(19) United States
(12) Patent Application Publication
(10) Pub. No.: US 2006/0293985 A1
(43) Pub. Date: Dec. 28, 2006

(54) System and method for securitizing tangible assets in the alternative financial services industry

(75) Inventors: Eric D. Lederman, Pacific Palisades, CA (US); Bruce R. Lederman, Pacific Palisades, CA (US); Larry R. Raymond, River Forest, IL (US); Ellen L. Marks, Chicago, IL (US)

Correspondence Address: Stephen P. Gilbert, Esq.;BRYAN CAVE LLP, 1290 Avenue of the Americas, New York, NY, 10104, US

(73) Assignee: Securitization Group, LLC

(21) Appl. No.: 11/168,148

(22) Filed: Jun. 27, 2005

(51) Int. Cl. G06Q 40/00

(52) U.S. Cl. 705/35

(57) ABSTRACT

Methods for securitizing and facilitating the securitization of the pawned assets of a pawnshop to enable the pawnshop to obtain a greater amount of funding at reduced rates and to tap into sources of financing in addition to traditional markets. The pawnshop can sell the pawned assets to a first entity to obtain immediate funding, which the first entity can obtain directly or indirectly from other entities in transactions involving a secured financial instrument. Depending on the transactions used, either on-balance sheet or off-balance sheet treatment for the pawnshop of the pawned assets and related liabilities is possible.

### BACKGROUND OF THE INVENTION AND OTHER INFORMATION

This invention concerns a system and method for securitizing tangible (physical) assets in the alternative financial services industry, particularly for pawnshop enterprises. Securitization enables a company to obtain financing in greater amounts and at more favorable rates than are usually available through other traditional forms of financing.

The alternative financial services (“AFS”) industry comprises financial service providers operating outside the system of governmentally insured financial institutions. Services of the AFS industry include check cashing, payday lending, rent-to-own agreement lending, rental agreement lending, sub-prime lending, refund anticipation lending, vehicle title pawn lending, and traditional pawnbrokering. Total business volume is difficult to estimate but is likely well over $100 billion per year in the United States and may be several times that amount. The AFS industry constitutes a major source, and often the only source, of credit and banking services for individuals with heavy debt burdens or less favorable credit histories and/or no other traditional banking relationships. The above-listed AFS enterprises are described as follows:

Check cashing outlets provide access to cash by cashing checks, such as paychecks and benefits checks, for a per-check fee.

Payday loans (also called “deferred presentments” or “payday advances”) are small cash advances based on personal checks held by the lender for a scheduled period of time, generally either until the next payday or a one- or two-week period. On that date, the consumer allows the check to be deposited, pays off the loan, or pays another fee and renews the loan for another period of time. There were believed to be about 22,000 payday advance outlets in the United States in 2004.

Rent-to-own lenders (using rent-to-own agreements) allow consumers to acquire household goods, appliances, electronics, and the like through installment payments.

Rental agreement lending (loans based on rental agreements) is similar, a major difference being that the right to eventually own the items rented is not part of the arrangement.

Sub-prime lenders make loans (i.e., extend credit, both on a secured and unsecured basis) to people considered to be higher credit risks.

Refund anticipation lenders make cash loans against the customer's (borrower's) expected income tax refund.

In a vehicle title loan transaction (title pawn lending), a borrower brings a vehicle and its title (the vehicle is usually an automobile but could be a truck, motor home, recreational vehicle, aircraft, watercraft, etc.) to a title loan/pawn lender (also known as a “title broker” or an “auto title lender”) and pawns the title while keeping the vehicle.

Finally, traditional pawns are structured as sales of the customer's property (“collateral” or “pawned asset”) to the pawnbroker, subject to the right of redemption. In most cases, pawn transactions can take the form of a “buy-sell agreement” involving the actual sale of the property to the pawnbroker by the customer with an option given to the customer to repurchase it (right of redemption) within a specified period of time.

In the United States in 2004, there were approximately 15,000 pawnshops, with four public companies operating approximately half of them, and the total business volume was estimated to be well over $4 billion per year. Pawn businesses and their operations may be referenced by a variety of terms, including “pawnshop,” “pawnshop operation,” “pawnshop enterprise,” “pawn store,” “pawnshop business,” “pawning,” “pawn operation,” “pawnbrokering,” “pawnbrokerage,” and the like. All of those terms may be used interchangeably herein to refer to pawn operations.

Pawnshops are convenient sources of consumer financing and are sellers of previously owned merchandise acquired from pawnshop customers who do not redeem their pawned assets. In the United States, the pawned assets are generally tangible personal property other than securities or printed evidence of indebtedness and include all manner of personal property, including but not limited to, jewelry, tools, televisions, stereos, musical instruments, appliances, and firearms.

In a pawn transaction, the customer brings the item he or she wishes to pawn to the pawnshop. It is appraised by the pawnshop operator, and if the price offered is satisfactory to the customer, the pawnshop then purchases the item. Both legal title and physical possession pass to the pawnshop. The customer receives cash and a right of redemption, i.e., the right (but not the obligation) to repurchase the pawned item within a specified period of time at a price significantly higher than the price the customer received when the customer sold the item to the pawnshop.

The customer has no obligation to redeem the pawned asset or to repay the amount he or she was paid by the pawnshop. Instead, the pawnbroker relies on the value of the pawned asset as security. Accordingly, the creditworthiness of the customer is not a factor, and the customer's decision not to redeem the pawned asset has no effect on his or her personal credit status.

When a pawn transaction is entered into, a pawn transaction agreement, commonly embodied in a pawn ticket, is delivered to the customer. The ticket sets forth, among other things, the name and address of the pawnshop and of the customer, additional identifying information about the customer (e.g., from his or her driver's license) the date of the pawn transaction, a description of the pawned asset, the purchase price, the added costs if the customer wishes to redeem the pawned asset (i.e., a finance and service fee), the maturity date (i.e., the last day the right of redemption can be exercised), and the total amount that must be paid to redeem the pawned asset.

The pawnshop charges a finance and service fee to compensate it for entering into the transaction and for the use of the finds expended. The finance and service fee is typically calculated as a percentage of the purchase price amount based on the size and duration of the transaction, in a manner similar to which interest is determined for a conventional loan, but at higher rates as permitted by applicable state pawnshop laws.

The purchase price that a pawnshop is willing to pay for a pawned asset is typically based on a percentage of the pawned asset's estimated disposition value. That disposition value may be determined using many different tools and sources, including automated proprietary valuation systems, catalogues, “blue books,” newspapers, internet research, and previous disposition experience with similar items. Pawnshops usually try to set the ratio of purchase price to estimated disposition value so that if the item is forfeited to the pawnshop (i.e., not redeemed), its subsequent disposition will yield the desired profit margin. Thus, recovery of the purchase price paid to the customer, as well as realization of a profit on sale of the pawned asset, are dependent on the pawnshop's initial assessment of the pawned asset's estimated disposition value. Erroneous assessment of that value may result in its disposition for an amount less than the amount advanced and, therefore, a loss. On average, pawnbrokers pay about one-half of the estimated disposition (resale) value of the pawned asset. Most pawnshop purchases in the United States are for $150 or less, and the average purchase price is about $70.

The pawned asset is held by the pawnshop through the redemption period, which usually is no more than six months, unless extended. Many redemption periods are extended, some several times, by the customer, who pays additional fees to do so.

Approximately 70 to 80 percent of pawned assets are eventually redeemed; however, if the customer does not repurchase the pawned asset during the redemption period, the unredeemed pawned asset, which is owned by the pawnshop, becomes available for disposition (typically sale to a party other than the customer). The customer is not obligated to pay any additional money to the pawnshop if the pawned asset sells for a lower price to a third party than the pawnshop paid for it, nor is the pawnshop obligated to pay any additional money to the customer if the pawned asset sells for a higher price.

After the pawned asset is purchased by the pawnshop, the asset does not generate an income stream (cash flow) until it is redeemed or purchased, but there is no assurance that it ever will generate an income stream (cash flow) because the customer is not obligated to repurchase it and the pawnshop has no assurance that it will be purchased by a third party after the redemption period expires.

Pawnbrokerages have not been able to utilize securitizations to obtain funding because the assets of a pawnbrokerage business are tangible (physical) assets that do not by their terms convert into cash within a finite period of time, which is a defining characteristic of the traditional financial assets required for securitizations (as will be understood by one skilled in the art, when the sense admits, the term “cash” should be broadly understood to include things that are readily converted into cash, e.g., so-called cash equivalents). In contrast, many other businesses, including certain AFS enterprises, have receivables (also called “accounts receivable”) or other financial assets that do, by their terms, convert into cash within a finite period of time. For example, when a bank makes a loan secured by a mortgage on a residence, the terms of the loan and related mortgage obligate the borrower to make periodic payments, thereby providing a cash flow to the bank. As a result, such businesses can readily use the process of “securitization” (also called “asset-backed financing,” “structured financing,” “asset-backed securitization,” and “asset securitization”) to receive funding with respect to their financial assets before the cash payments on those assets are received, at favorable rates and in significant amounts. As is well-known, securitizations are effective in reducing borrowing costs and diversifying funding resources but require and are based on financial assets, i.e., assets that convert into cash by their terms within a finite period of time.

Securitization is a financing technique used to create securities based on assets that, by their terms, convert into cash within a finite period of time (generate cash flows). In securitization transactions, investors purchase securities (“asset-backed securities” or “ABS”) is that are entitled to receive specified portions of the collections of receivables or the right to receive a specified portion of the cash flows received in payment of certain assets. Those assets have first been isolated from the insolvency risk of the operating company that originated, acquired, or owned those assets prior to the securitization. In other words, those assets and the cash flow derived from them (and the right to receive the cash flow) are first segregated and the right to receive all or a portion of those cash flows and/or an ownership interest in the assets are then sold to investors.

As used herein, “securitizing,” “securitized,” “securitizes,” and the like should be broadly understood and refer to the act of facilitating (e.g., causing, participating in, structuring, financing, negotiating, or otherwise facilitating) a securitization. Thus, an underwriter may cause, participate in, structure, finance, negotiate, or otherwise facilitate a securitization by, e.g., underwriting securities backed by one or more financial instruments. An investment entity (e.g., a trust) may cause, participate in, structure, finance, negotiate, or otherwise facilitate a securitization by creating, issuing, or offering the securities. A pawnshop enterprise may cause, participate in, structure, negotiate, finance, or otherwise facilitate a securitization by, e.g., transferring pawned assets to a bankruptcy-remote entity. Still other parties may cause, participate in, structure, finance, negotiate, or otherwise facilitate a securitization by, e.g., rating, purchasing, or transferring the securities.

The terms “security” and “securities” should be broadly understood to refer to any type of financial instrument, whether representing equity, debt, or otherwise, and include trust certificates, trust interests, fractional individual interests, notes, commercial paper, and preferred stock, regardless of preference level, regardless of how public or private or broad or limited the market for that security is. Additional examples of securities include bonds, debentures, evidence of indebtedness, certificates of interest, collateral-trust certificates, investment contracts, certificates of deposit for a security, any derivatives (puts, calls, straddles, options), or privileges on any security, or any certificates of interest or participation in, temporary or interim certificates for, receipts for, guarantees of, or warrants or rights to subscribe to or purchase, any of the foregoing.

The securitization industry began with mortgage loans and has spread to many asset classes, with asset-backed securities based at various times on credit card receivables, home equity loans, auto loans and leases, entertainment royalties, bank loans, boat loans, recreational vehicle loans, aircraft leases, student loans, computer leases, medical equipment leases, insurance premiums, vacation timeshares, toll road receivables, mutual fund fees and health care receivables, among other assets. In all of these cases, where a physical asset is related to the securitization, the asset securitized is not the physical asset (e.g., a building, an automobile, or a toll road) but is, instead, a financial asset created by the financing of the physical asset. For example, the financial asset securitized would be a mortgage loan in the case of a home or an auto loan in the case of an automobile. In such cases, the financial asset (the mortgage loan or the auto loan) is a debt obligation that is backed by a security interest in a physical asset. Securitization is based primarily on the use of financial assets that by their terms convert into cash within a finite period of time. As far as is known to the present inventors, physical assets alone (i.e., physical assets that do not have a predictable income stream or by their terms convert into cash within a finite period of time) have not been securitized (in certain timber transactions, securitization of the complete timber business of a company (including the trees and logs) has occurred).

In a basic securitization structure, financial assets that generate cash flows, such as receivables, mortgages, loans, etc., are pooled together by asset class. Securities based on that pool of financial assets (often with different maturities, interest rates, liquidation or payment seniority, or other features) are issued and sold to investors, who are thereafter repaid from the cash flow generated by the financial assets being securitized through collections or payments of the sums due pursuant to the terms of such financial assets. The transaction's originator or sponsor (who has originated or otherwise acquired the pool of financial assets) often receives the residual cash flows above those necessary to make full payments to the investors. The right to residual cash flows may also be sold to third party investors. Often the asset-backed securities are “rated” by credit rating organizations such as Standard & Poor's and Moody's Investor Services. The higher the rating, the easier it is to borrow and the lower the interest rate that must be paid by the borrower. Asset-backed securities may receive credit ratings as high as AAA (or Aaa, for Moody's) even if the companies owning or originating the securitized assets themselves have lower credit ratings because (i) the assets and related cash flows (and rights thereto) are isolated from the insolvency risk of such companies and (ii) various “credit enhancements,” such as over-collateralization, excess spread (the amount by which yield from the assets exceeds the expenses of the securitization), a cash holdback or reserve, cash collateral account, guarantees from more credit-worthy entities, insurance policies, letters of credit, and other mechanisms can be used to support the transaction and mitigate its risks.

There are two basic types of securitizations. In the first type, the pool of assets securitized is fixed and principal is repaid to investors on a periodic basis from the cash flows that are received over time. Examples of assets commonly supporting these types of securitizations are those in which the obligor on the underlying asset does not borrow additional sums in the ordinary course, such as mortgages and auto loans. In the second type, the pool of assets is revolving and principal is typically not repaid to investors until a future specified time after the transaction is initiated or at an earlier time if certain performance levels that trigger an early paydown deteriorate. All collections in this second type are typically reinvested in new assets until they are needed to make the required repayments. The reinvestment period is typically referred to as the “revolving period” or “reinvestment period” and the period in which principal is repaid is typically referred to as the “amortization period,” “liquidation period,” or “paydown period.” Examples of the second type of securitization are credit card and trade receivables financings, which are securitizations where the obligors on the underlying assets are expected to continually repay outstanding balances and may borrow new amounts from the same lender. A securitization may have features of both structures.

Investors in asset-backed securities differ from investors in corporate securities and operating companies in that the important information to ABS investors is information about the transaction structure and the quality of the asset pool, unlike corporate investors more typical emphasis on financial statements, management, and operations.

Securitization helps companies of all sizes achieve financing at lower rates but may be particularly beneficial to companies with low corporate credit ratings and to smaller (often privately held) companies because it can give them access to otherwise unavailable capital markets, such as the commercial paper market. Smaller companies may take advantage of securitization and obtain lower borrowing costs and access to those other capital markets by transferring their receivables or issuing securities backed by such receivables to a consolidating entity, such as a special purpose conduit, that pools receivables (or securities backed by receivables) into one large pool and then selling securities whose repayments are based on the cash flow generated by all of the receivables in that entire pool.

The only patent documents dealing with securitizations known to the present investors consist of U. S. Patent No. 6,654,727 (“Method Of Securitizing A Portfolio Of At Least 30% Distressed Commercial Loans”) and U. S. Patent Application Publication Nos. 2003/0144950 (“Loan Securitization Pool Having Pre-Defined Requirements”) and 2003/0163414 (“Management Of Multiple Loan Securitization Pools”). All of the documents referenced or otherwise cited herein, including the foregoing, are incorporated herein in their entireties for all purposes.

As a result of the foregoing, the need exists for means by which pawnshop enterprises can securitize their pawned assets and obtain the benefits of such financing: more money at a lower cost. The advantages of being able to do so, whether for individual pawnshops or for pawnshop chains, are clear. The advantages for enterprises that contain both pawnshop and non-pawnshop businesses are also clear because the size of the securitizations they will be able to execute will be increased by their ability to use the pawnshop assets in such securitizations.

### BRIEF SUMMARY OF THE INVENTION

An invention that satisfies one or more of those needs and provides still other benefits that will be apparent to those skilled in the art has now been developed. Broadly, this invention concerns a method for facilitating the securitization of the pawned assets of a pawnshop enterprise, the method comprising the steps:

(a) causing, participating in, structuring, financing, negotiating, or otherwise facilitating the transfer of at least some of the pawnshop enterprise's pawned assets to a first entity for a first consideration; and

(b) causing, participating in, structuring, financing, negotiating, or otherwise facilitating the transfer (e.g., assignment or issue) of a secured financial instrument to a second entity for a second consideration, the secured financial instrument being secured at least in part by at least some of the pawned assets that were transferred by the pawnshop enterprise.

The invention also concerns a method for a pawnshop enterprise to facilitate securitization of its pawned assets, the method comprising the steps:

(a) causing, participating in, structuring, financing, negotiating, or otherwise facilitating the transfer of at least some of its pawned assets to a first entity for a first consideration; and

(b) causing, participating in, structuring, financing, negotiating, or otherwise facilitating the transfer (e.g., assignment or issue) of a secured financial instrument to a second entity for a second consideration, the secured financial instrument being secured at least in part by at least some of the pawned assets that were transferred by the pawnshop enterprise.

The invention also concerns a method for securitizing at least some of the pawned assets of a pawnshop enterprise, the method comprising creating, issuing, underwriting, or offering securities backed by the secured financial instrument.

In various embodiments, the secured financial instrument is created or issued by the first entity or by a third entity; and/or the transfer of the pawnshop enterprise's pawned assets to the first entity comprises a true sale and/or a true contribution; and/or the first consideration comprises cash and/or a note and/or equity in the first entity; and/or the first consideration comprises a subordinated note; and/or the first entity is bankruptcy-remote; and/or the first entity is a wholly owned subsidiary of the pawnshop enterprise; and/or the first entity is a special purpose entity; and/or the second consideration comprises cash and/or a note and/or a deferred purchase price; and/or the second consideration comprises a loan; and/or payment of the deferred purchase price to the first entity is contingent upon the performance of the pawnshop enterprise (e.g., in selling the pawned assets securing the secured financial instrument); and/or the second entity is an entity that can transfer beneficial interests in the secured financial instrument to investors; and/or the second entity is a trust; and/or at least some of the pawnshop enterprise's pawned assets are transferred by the first entity to the third entity for a third consideration; and/or the transfer of at least some of the pawnshop enterprise's pawned assets by the first entity to the third entity comprises a true sale; and/or the third entity is bankruptcy-remote; and/or the third entity is a special purpose entity; and/or the third entity is a special purpose entity whose allowed activities comprise purchasing the pawned assets for the third consideration; and/or the third consideration comprises the secured financial instrument and/or cash and/or a subordinated note and/or a deferred purchase price; and/or the method further comprises causing, participating in, structuring, financing, negotiating, or otherwise facilitating the transfer (e.g., assignment or issue) to the second entity of one or more other financial assets in addition to the secured financial instrument (the other financial assets, preferably but not necessarily of the pawnshop enterprise in question, may be transferred to the second entity by any entity, preferably but not necessarily an entity in the structure of the system of this invention, so long as the securities that are issued by the second entity are ultimately based directly or indirectly on the combination, i.e., bundle, of assets, which includes at least some assets stemming from the pawnshop enterprise in question); and/or the second consideration is given in return for the one or more financial assets and secured financial instrument; and/or at least one of the other financial assets is transferred to the first entity by the pawnshop enterprise; and/or the one or more financial assets comprise or involve instruments based on check cashing, payday loans, rent-to-own agreements, rental agreements, sub-prime loans, refund anticipation loans, and/or title pawn loans.

In one preferred embodiment, at a minimum, the transfer of the pawnshop enterprise's pawned assets to the first entity comprises a true sale and/or a true contribution, the first consideration comprises cash and/or a note and/or equity in the first entity, the first entity is bankruptcy-remote, the second consideration comprises cash and/or a note and/or a deferred purchase price, and the second entity is an entity that can transfer beneficial interests in the secured financial instrument to investors.

In other preferred embodiments, at a minimum, the transfer of the pawnshop enterprise's pawned assets to the first entity comprises a true sale and/or a true contribution, the transfer of at least some of the pawnshop enterprise's pawned assets by the first entity to the third entity comprises a true sale, the secured financial instrument is created or issued by the third entity, the first consideration comprises cash and/or a note and/or equity in the first entity, the first entity is bankruptcy-remote, the second consideration comprises cash and/or a note and/or a deferred purchase price, the second entity is an entity that can transfer beneficial interests in the secured financial instrument to investors, the third entity is bankruptcy-remote, and the third consideration comprises the secured financial instrument and/or cash and/or a subordinated note and/or a deferred purchase price.

The present invention provides several significant benefits.

First, it enables a pawnshop enterprise to create a financial asset from its physical assets, which financial asset can be used to support a securitization. In other words, the present invention allows pawnshop enterprises to convert their tangible (physical) assets, which do not by their terms convert into cash within a finite period of time, into financial assets that do and, therefore, can be securitized.

Second, in some embodiments, the invention enables the pawnshop enterprise to utilize securitizations in either an “on-balance sheet” or “off-balance sheet” manner, the latter of which may be important because it usually makes the company's balance sheet, and therefore the company, more attractive to potential lenders and investors. The primary goal of off-balance sheet securitizations is to remove the securitized assets and related liabilities from the financial statements of the companies making use of the securitizations. Financial reporting rules relating to securitizations are set forth in various accounting rules and regulations, including “FAS 140” (Financial Accounting Standards Board, Statement Of Financial Accounting Standards No. 140, “Accounting for Transfers and Servicing of Financial Assets and Extinguishment of Liabilities”). FAS 140, which permits off-balance sheet treatment for certain transfers of financial assets, addresses only transfers of financial assets and does not address off-balance sheet treatment for transfers of physical assets. Under FAS 140, a physical asset (e.g., a pawned asset) is not a “financial asset,” which is defined as “[c]ash, evidence of an ownership interest in an entity, or a contract that conveys to a second entity a contractual right (a) to receive cash or another financial instrument from a first entity or (b) to exchange other financial instruments on potentially favorable terms with the first entity” (FAS 140, page 135 (September 2000)).

Because FAS 140 does not apply to the transfers of physical assets in this invention and no other specific body of accounting guidance addresses the transfer of physical assets in these circumstances, the off-balance sheet methods of the invention rely on achieving “sale treatment” (defined below) of the pawned assets to a third party and on various general accounting principles. Any transaction utilizing the off-balance sheet methods of this invention will have to ensure that the pawnshop enterprise with its subsidiaries are not the “primary beneficiaries” of a “variable interest entity” to avoid consolidation of the variable interest entity on the financial statements of the pawnshop enterprise pursuant to “Fin 46(R)” (FAS Interpretation No. 46(R), “Consolidation of Variable Interest Entities”), which consolidation would prevent off-balance sheet treatment. It is believed that the third-party purchase of the pawned assets can be structured so that the pawnshop entity in question is not the primary beneficiary. For example, adding sufficient amounts of pawned assets from unrelated pawnshops to the pawned assets being transferred by the pawnshop entity in question would prevent the pawnshop entity from being the primary beneficiary and thereby prevent such consolidation under Fin 46(R).

Third, in some embodiments, the invention enables one or more AFS entities (one of which is a pawnbrokerage operation) having both physical assets and financial assets to utilize the different types of assets in one securitization vehicle. Thus, a company or group of companies can support a securitization using all or almost all of its or their combined assets. In other words, the present invention allows assets to be bundled together, e.g., so that a single loan may be obtained using an enterprise's or group's assets, some of which are pawned (physical) assets and some of which are financial assets. More specifically, the following AFS assets can be combined in a single securitization vehicle: traditional financial assets (e.g., sub-prime personal loans, checks, leases, and payday loans, which are financial assets representing fixed and certain cash flows and therefore, by their terms, convert into cash within a finite period of time) and financial assets based on pawned items (which items are physical assets that do not by their terms convert into cash). The combination of various AFS asset categories in a single securitization vehicle avoids the need for multiple lenders, avoids conflicting lender requirements, saves time, saves transaction costs as compared to multiple separate securitizations of different categories, and enables a company to obtain greater amounts of financing at more favorable rates than it otherwise could obtain. In short, it is a more efficient way of borrowing.

The AFS industry has not to date used securitization to obtain financing for pawnshops or for many of the other AFS businesses. Being able to securitize a pawnshop's pawned assets is an important step in making securitization available to the AFS industry because many companies involved in pawnbrokerage are also involved in other parts of the AFS industry (e.g., check cashing and payday loans), and the present invention enables such AFS companies to securitize their different types of assets in a common securitization vehicle.

The securitization industry makes large sums of money (in the hundreds of billions of dollars annually) available to companies able to fulfill the strict requirements for a typical securitization. By being able to utilize this market, a pawnshop enterprise can obtain the following benefits: it obtains funding at a lower cost, since the securities issued in a securitization can almost always achieve a higher credit rating than the pawnshop enterprise; it can obtain a greater amount of funding than through traditional lending sources because of the basic structure of the securitizations (using bankruptcy-remote entities and pooling assets independent of liabilities); and it can diversify its borrowing by tapping into the securitization market in addition to using the more traditional lending sources. Also, because the invention results in more funding alternatives being available, competition among potential lenders for that loan business should help drive down borrowing rates and allow the pawnshop enterprise to borrow more money than would otherwise be available to it. Furthermore, the ability to engage in off-balance sheet financing may better enable a pawnshop enterprise to present a balance sheet that meets the stringent financial requirements necessary to obtain lower interest rate loans, or larger loans, from traditional lending sources.

The present invention enables a pawnshop enterprise to enhance its borrowing power, which includes obtaining higher loan amounts and/or lower borrowing rates. Still other features and advantages of this invention will be apparent to those skilled in the art from this disclosure.

### BRIEF DESCRIPTION OF THE DRAWINGS

To facilitate further description of the invention, the following drawings are provided in which:

FIG. 1 shows a generalized system and method of this invention that may be used for on-balance sheet securitization of the assets of a pawnshop;

FIG. 2 shows the initial set-up of a specific structure and method for implementing the generalized system and method of FIG. 1, including the initial flow of pawned assets, secured note, and other consideration (e.g., cash);

FIG. 3 shows for the specific structure and method of FIG. 2 the cash and other flows during the revolving period, i.e., the period during which pawned assets that have already been securitized are redeemed and new assets are pawned;

FIG. 4 shows for the specific structure and method of FIG. 2 the cash and other flows during the amortization period, up to the point the secured note has been fully paid off;

FIG. 5 shows for the specific structure and method of FIG. 2 the cash and other flows during the amortization period, after the secured note has been fully paid off and while special purpose entity number 1 (SPE #1) is making payments on its subordinated note;

FIG. 6 shows a generalized system and method of this invention that may be used for off-balance sheet securitization of the assets of a pawnshop;

FIG. 7 shows the initial set-up of a specific structure and method for implementing the generalized system and method of FIG. 6, including the initial flow of pawned assets, senior and subordinated secured notes, and other consideration (e.g., cash);

FIG. 8 shows for the specific structure and method of FIG. 7 the cash and other flows during the revolving period, i.e., the period during which pawned assets that have already been securitized are redeemed;

FIG. 9 shows for the specific structure and method of FIG. 7 the cash and other flows during the amortization period, before the senior secured note has been fully paid off and before the second special purpose entity pays any part of its subordinated secured note held by the first special purpose entity;

FIG. 10 shows for the specific structure and method of FIG. 7 the cash and other flows during the amortization period, when the cash flow is sufficient for the second special purpose entity to pay the deferred purchase price evidenced by its subordinated secured note held by the first special purpose entity;

FIG. 11 shows for the specific structure and method of FIG. 7 the cash and other flows during the amortization period, after the senior secured note and the subordinated secured note have been repaid.

FIG. 12 shows an alternative generalized system and method of this invention that may be used for either an off-balance sheet or an on-balance sheet securitization of the assets of a pawnshop;

FIG. 13 shows the initial set-up of a specific structure and method for implementing the generalized system and method of FIG. 12, including the initial flow of pawned assets, secured note, and other consideration (e.g., cash);

FIG. 14 shows for the specific structure and method of FIG. 13 the cash and other flows during the revolving period, i.e., the period during which pawned assets that have already been securitized are redeemed and new assets are pawned;

FIG. 15 shows for the specific structure and method of FIG. 13 the cash and other flows during the amortization period, before the second special purpose entity's secured note has been fully paid off and before the third party investor pays any part of the deferred purchase price for the secured note to the first special purpose entity;

FIG. 16 shows for the specific structure and method of FIG. 13 the cash and other flows during the amortization period, when the cash flow is sufficient for third party investor to pay to the first special purpose entity the deferred purchase price for the secured note; and

FIG. 17 shows for the specific structure and method of FIG. 13 the cash and other flows during the amortization period, after the second special purpose entity's secured note, the deferred purchase price for the secured note, and the first special purpose entity's note have been repaid.

These drawings, which are part of this application and disclosure, are for illustrative purposes only and should not be used to unduly limit the scope of the present invention.

### DETAILED DESCRIPTION OF THE INVENTION

The invention provides methods for securitizing and facilitating the securitization of the pawned assets of a pawnshop enterprise, thereby enabling the pawnshop enterprise to realize a number of benefits, including obtaining a greater amount of funding at reduced rates and tapping into sources of financing in addition to traditional markets. Broadly, in one aspect, this invention concerns a method for facilitating the securitization of the pawned assets of a pawnshop enterprise, the method comprising the steps:

(a) causing, participating in, structuring, financing, negotiating, or otherwise facilitating the transfer of at least some of the pawnshop enterprise's pawned assets to a first entity for a first consideration; and

(b) causing, participating in, structuring, financing, negotiating, or otherwise facilitating the transfer (e.g., assignment or issue) of a secured financial instrument to a second entity for a second consideration, the secured financial instrument being secured at least in part by at least some of the pawned assets that were transferred by the pawnshop enterprise.

In another aspect, the invention concerns a method for a pawnshop enterprise to facilitate securitization of its pawned assets, the method comprising the steps:

(a) causing, participating in, structuring, financing, negotiating, or otherwise facilitating the transfer of at least some of its pawned assets to a first entity for a first consideration; and

(b) causing, participating in, structuring, financing, negotiating, or otherwise facilitating the transfer (e.g., assignment or issue) of a secured financial instrument to a second entity for a second consideration, the secured financial instrument being secured at least in part by at least some of the pawned assets that were transferred by the pawnshop enterprise.

In yet another aspect, the invention concerns a method for securitizing at least some of the pawned assets of a pawnshop enterprise, the method comprising creating, issuing, underwriting, or offering securities backed by the secured financial instrument.

In one preferred embodiment of the invention, the pawnshop enterprise transfers (e.g., sells in a true sale and/or contributes in a true contribution) at least some of its pawned assets to a first entity, which pays a first consideration for those assets to the pawnshop enterprise (e.g., cash, a subordinated note, and/or equity in the first entity). The first entity transfers to a second entity (e.g., a third-party investor, such as a master trust) a financial instrument (e.g., a note the first entity has made) secured by the pawned assets transferred to it and receives in return a second consideration for the note (e.g., cash, such as in the form of a loan). The second entity can issue certificates backed by the secured note to investors, who pay cash to the second entity for the certificates.

Under current accounting standards, particularly if the first entity is closely enough related or tied to the pawnshop enterprise, this first embodiment will usually result in the transaction being included on the consolidated balance sheet of the pawnshop enterprise; however, the following variation will under current accounting standards facilitate keeping the transaction off the consolidated balance sheet.

In this second preferred embodiment, there is a third entity. The pawnshop enterprise transfers (e.g., sells in a true sale and/or contributes in a true contribution) at least some of its pawned assets to the first entity, which pays a first consideration for those assets to the pawnshop enterprise (e.g., cash, a note, and/or equity in the first entity). The first entity transfers (e.g., sells in a true sale) at least some of the pawned assets it receives to the third entity, which furnishes a third consideration to the first entity. The third entity transfers to the second entity a senior secured financial instrument (e.g., a note it has made), secured by the pawned assets, and receives in return the second consideration, which may be cash in the form of a loan. The third consideration (flowing from the third entity to the first entity in return for the pawned assets flowing from the first entity to the third entity) may be cash and/or a subordinated note secured by the pawned assets and/or a deferred purchase price. As before, the second entity (e.g., a third party investor, such as a master trust) can issue certificates backed by the secured note to investors, who pay cash to the second entity for the certificates.

A third preferred embodiment may also, under current accounting standards, facilitate keeping the transaction off the consolidated balance sheet of the pawnshop enterprise. In this embodiment, there is again a third entity. As before, the pawnshop enterprise transfers (e.g., sells in a true sale and/or contributes in a true contribution) at least some of its pawned assets to the first entity, which pays a first consideration for those assets to the pawnshop enterprise (e.g., cash, a note, and/or equity in the first entity), and the first entity transfers (e.g., sells in a true sale) at least some of the pawned assets it receives to the third entity, which furnishes a third consideration to the first entity. In this embodiment, however, the third entity does not need to deal directly with the second entity. Rather, the third entity transfers to the first entity as or as part of the third consideration a secured financial instrument (e.g., a note the third entity has made), secured by the pawned assets, and the first entity transfers the secured financial instrument to the second entity (e.g., a third-party investor, such as a master trust) for the second consideration (e.g., cash and/or a note and/or a deferred purchase price). As before, the second entity can issue certificates backed by the secured note to investors, who pay cash to the second entity for the certificates.

As used herein, the term “asset-backed security” means a security that is primarily serviced by the cash flows of a discrete pool of receivables or other financial assets, either fixed or revolving, that by their terms convert into cash within a finite time period, plus any rights or other assets designed to assure the servicing or timely distributions of proceeds to the security holders. “Asset-backed security” should be broadly understood to also include, but not be limited to, other securities that are backed by a pool of receivables or other financial assets that may not be discrete pools (for instance, where trading of pool assets is permitted), securities issued in the form of rights under a credit swap obligation structure, credit derivatives pool or total return swaps, and other securities that are commonly considered to be structured finance securities or synthetic asset-backed securities.

As used herein, the term “pawn” and the like (whether a noun, verb, or otherwise) should be broadly understood. As indicated above, traditional pawns are structured as sales of the customer's property to the pawnshop, subject to the right of redemption. Pawn transactions usually take the form of a buy-sell agreement involving the actual sale to the pawnshop of the property with an option to repurchase it (also called a “right of redemption”). The pawned property is often referred to herein as the “pawned asset” or “pawned item,” which terms should be broadly understood.

The term “pawnshop enterprise” should be broadly understood and includes one or more businesses together, at least one of which is engaged in pawnbrokerage. Thus, e.g., a pawnshop enterprise may comprise a single pawnshop; a plurality of pawnshops under common control and/or ownership; a plurality of pawnshops not under common control or ownership that join together for one or more purposes, including the purpose of utilizing the present invention; or a combination of any of the foregoing.

Each of the first entity, second entity, and third entities may be any type of person, whether natural or juridical (e.g., corporation, limited liability company, limited partnership, or foreign equivalents thereof), that is lawfully able to participate in the various embodiments of the present invention.

The first entity desirably is bankruptcy-remote. In other words, broadly speaking, the first entity would have safeguards against a bankruptcy filing to the extent permitted by law, such as an independent director with power to veto any such filing, it would have no or very limited ability to incur debt other than in connection with the securitization, it would have no or very limited ability to engage in any business other than the securitization, and it would be obligated to maintain its corporate separateness, etc., such that the assets of the first entity would not be substantively consolidated under the bankruptcy doctrine of “substantive consolidation” with the assets of any other entity in case of that other entity's bankruptcy. Thus, e.g., in case of the pawnshop enterprise's bankruptcy, a bankruptcy court would not determine that the first entity should be substantively consolidated with the pawnshop enterprise such that all assets and liabilities of each would be treated as assets and liabilities of the same enterprise. The first entity may be owned by the pawnshop enterprise, e.g., be a wholly owned subsidiary of the pawnshop enterprise. The first entity may also be a special purpose entity.

The term “special purpose entity” (sometimes abbreviated in this application, including in the drawings, as “SPE” and also known as a “special purpose vehicle”) should be broadly understood and refers to a business interest formed solely in order to accomplish one or more specific tasks, including being bankruptcy-remote, and usually for a single or very limited, well-defined, and narrow purpose. Therefore, the powers of an SPE as specified in its charter or other organizational documents are usually limited to those that might be required to attain that purpose. The SPE may have any permissible legal form, such as corporation, limited liability company, partnership, trust, or unincorporated entity. An entity may be identified as being a special purpose entity by its single-limited purpose nature and its having one or more of certain features, including an independent director and restrictions on its permitted activities.

The second entity will typically be a trust or any other party that receives the secured financial instrument and can transfer beneficial interests in the secured financial instrument to investors (e.g., as evidenced by certificates or notes) in return for their furnishing capital (cash). The second entity desirably is also bankruptcy-remote. In other words, broadly speaking, the second entity would have safeguards against a bankruptcy filing to the extent permitted by law such that the assets of the second entity would not be substantively consolidated with the assets of any other entity in case of that other entity's bankruptcy. The second entity may or may not be at risk of being substantively consolidated in bankruptcy with the third entity.

The third entity desirably is bankruptcy-remote. In other words, broadly speaking, the third entity would have safeguards against a bankruptcy filing to the extent permitted by law such that the assets of the third entity would not be substantively consolidated with the assets of any other entity in case of that other entity's bankruptcy. The third entity will typically not be owned or controlled by the pawnshop enterprise. The third entity may also be a special purpose entity.

The term “consideration” should be broadly understood and includes any benefit conferred, or agreed to be conferred, upon the person (whether natural or juridical) receiving the consideration, including any labor, detriment, or inconvenience sustained by the person (whether natural or juridical) furnishing the consideration.

The term “secured financial instrument” should be broadly understood and refers to a financial instrument that is secured.

The term “financial instrument” should be broadly understood and refers to an instrument having monetary value or that represents a monetary transaction, including (i) a debt instrument, which arises out of a loan and represents an agreement to repay funds, and (ii) an equity security, which consists of shares or stock in a company. As used herein, “financial instrument” includes a financial asset. A financial instrument in one sense is a document containing or evidencing some legal right or obligation (e.g., a note or a contract). Common examples of financial instruments include demand and time deposits, commercial paper, accounts, notes, loans receivable and payable, debt and equity securities, asset-backed securities, derivatives (including options, rights, warrants, futures contracts, forward contracts, and swaps), leases, insurance contracts, and pension contracts. The secured financial instrument used in the present invention may be any legally appropriate financial instrument that allows the benefits of this invention to be realized and may, e.g., be a note, whether or not the note is a “negotiable instrument” under Article 3 of the Uniform Commercial Code (“UCC”). (Under UCC § 3-103, a negotiable instrument is a “note” if it is a promise, i.e., a promise to pay, or is a “draft” if it is an order, i.e., an order to pay.)

The term “secured” and the like should be broadly understood and indicate that security in some manner or form has been given (e.g., to provide protection or assurance to a creditor that a debt owed to the creditor by the debtor will be paid) and does not specifically require that either Article 8 or Article 9 of the Uniform Commercial Code apply, provided, however, that to the extent applicable law would govern such security, the security should be granted in a manner that desirably achieves the protections of such law. Security may be an obligation, pledge, mortgage, deposit, lien, etc. given by a first party, or by a second party on behalf of the first party, to a third party to make sure the payment or performance of a principal debt or obligation owed by the first party to the third party. In other words, the security is a resource that can be relied on by the third party if the first party fails to perform its principal obligation to the third party (e.g., make timely installment repayments of a loan). The secured financial instrument used in the present invention desirably is secured by using at least some of the pawnshop enterprise's pawned assets as security. The pawned assets may be used as security in any legally appropriate manner that allows the benefits of this invention to be achieved, e.g., by granting a security interest in the pawned assets under Article 9 of the Uniform Commercial Code. Thus, for example, if the monies owed pursuant to the secured financial instrument are not timely paid, the holder of the secured financial instrument secured by the pawned assets may force the sale of the assets and obtain the sums realized from the sale to satisfy the underlying debt.

The term “securities backed by a secured financial instrument” and the like should be broadly understood to include both direct and indirect backing, whatever the financial, legal, or other nature of that backing and whether the securities are characterized as debt, equity, or otherwise.

A “subordinated note” is a note that gives the holder a claim ranked lower in priority than one or more specified other claims. For example, the rights in the security conferred by a subordinated secured note would be ranked lower in priority than the rights in the security conferred by a senior secured note. A subordinated secured note may also be referred to as a “second lien note.”

The term “pawned assets from a pawnshop enterprise,” “pawned assets that were transferred by the pawnshop enterprise,” “pawnshop enterprise's pawned assets,” and the like should be broadly understood and refer to assets that are and/or were owned or transferred by the pawnshop enterprise, regardless of who now owns or possesses those assets or how many entities and transactions removed from the pawnshop enterprise those assets are.

The terms “transfer,” “transferred,” and the like (as in the phrase “the transfer of at least some of the pawnshop enterprise's pawned assets to a first entity for a first consideration”) should be broadly understood and include granting, selling, warranting, alienating, remising, demising, releasing, conveying, assigning, transferring, depositing, and setting over. Transfers may be of tangibles (e.g., pawned assets) or intangibles (e.g., security interests, rights). A transfer of a thing may be made by giving to another party physical possession of the thing without also giving ownership (title), or may be made by giving ownership (title) to that party without also giving possession of the thing, or may be made by giving both ownership and possession of the thing to that party. Transfers may comprise contributions to capital. Transfer may comprise issuance of a secured financial instrument or of other financial assets or instruments. Transfers may comprise granting a mortgage, making a pledge, or creating and granting a security interest in and right of set-off against an asset.

A transfer may be of only one or more past, present, future, or contingent rights concerning an asset without also transferring possession and/or ownership of the asset, or vice versa. Thus, a transfer may include all rights, powers, and options of the transferring party thereunder, including, without limitation, the immediate and continuing right to claim for, collect, and receive payments in respect of transferred assets and the right to sell such transferred assets, or may include a smaller subset as the parties agree, as well as other monies payable with respect thereto, the right to give and receive notices and other communications, to make waivers or other agreements, to exercise all rights and options, and generally to do and receive anything that the transferring party was or may have been entitled to do or receive thereunder or with respect thereto, regardless of the manner or legal nature of the transfer. Thus, e.g., in the quoted phrase (“the transfer of at least some of the pawnshop enterprise's pawned assets to a first entity for a first consideration”), the pawnshop enterprise's pawned assets would be granted, sold, warranted, alienated, remised, demised, released, conveyed, assigned, transferred, deposited, set over, and/or the like directly or indirectly to the first entity.

The term “causing, participating in, structuring, financing, negotiating, or otherwise facilitating” (as in the phrase “causing, participating in, structuring, financing, negotiating, or otherwise facilitating the transfer of at least some of the pawnshop enterprise's pawned assets to a first entity for a first consideration”) should be broadly understood and includes determining the appropriate legal structure for a securitization, establishing any required special purpose entities, drafting and negotiating the terms of the legal agreements, establishing the cash flow mechanisms, establishing lockbox or other agreements with banks for use in connection with a securitization, transferring or purchasing the assets, contributing assets to the capital of a subsidiary or accepting such contribution, issuing or making the secured financial instrument, issuing, underwriting, rating, or offering securities, obtaining or providing credit support, backup liquidity lines, guarantees, or other credit enhancements, or otherwise directly or indirectly effecting or bringing about by command, authority, or force, taking part or sharing in, making easier, permitting or forbearing from restraining or preventing, spurring on, stimulating, giving help to, and fostering, regardless of the manner or legal nature of the causation, participation, etc. For example, in the quoted phrase, the specified transfer of those assets could be brought about by the board of directors of a pawnshop enterprise by approving transfer agreements and causing the officers of such pawnshop enterprise to execute such agreements.

The term “true sale” should be broadly understood to mean a transaction that legally and equitably removes the assets and any interest in the assets from the transferor (or its estate in case of a bankruptcy, insolvency, receivership, or similar structure or proceeding) and does not permit the transferor to unilaterally reclaim such assets or permit creditors of the transferor (or a bankruptcy receiver or trustee) to reclaim such assets on behalf of the transferor. A true sale may also be referred to as legal isolation of such assets from the transferor or from the insolvency risk of the transferor. Whether a particular transfer is a true sale depends on the facts and circumstances of the particular transaction and may involve, among other things, an analysis of whether the risks and benefits of the particular financial asset have passed from the transferor to the transferee (e.g., special purpose entity) and whether the transferor has received a fair consideration for those risks and benefits. For example, for there to be a true sale of the pawned assets, the price paid for them (including the rate of interest on any part of the price not paid immediately) will have to be a fair consideration, taking into account all the other facts and circumstances of the particular transaction.

The determination of whether a transfer is a true sale is decided under the law of the appropriate jurisdiction. Thus, the requirements for true sale may vary from jurisdiction to jurisdiction and be set forth by statute and/or be determined under the common law. Within the United States, whether a true sale has occurred will likely be determined by the bankruptcy courts or, for certain organizations such as banks that are not be subject to bankruptcy but instead are subject to special regimes of receivership or insolvency, which may establish different rules for determining whether an asset can be reclaimed or recharacterized as property of the originator (transferor), the determination will be made by the receiver or other entity responsible for administering such regime.

The terms “sale treatment,” “off-balance sheet treatment,” and the like should be broadly understood and refer to the transfer by an enterprise of an asset to be securitized that (i) meets the requirements of a “true sale” (defined above) or “true contribution” (defined below) and (ii) meets the requirements of applicable generally accepted accounting principles (“GAAP”) so as to prevent the inclusion of such securitized asset and related liabilities on the consolidated financial statement of such enterprise. Thus, such treatment requires not just a true sale or a true contribution but also that generally accepted accounting principles not prevent such treatment, e.g., by requiring consolidation pursuant to Fin 46(R).

In a securitization, a true sale is important because it gives the transferee all right, title, and interest in the assets being transferred. True sale forms the line of demarcation between securitization and collateralized lending, i.e., a loan secured by the assets. As indicated above, securitization requires that the first transferee of the assets have all right, title, and interest in the assets so that its rights (and the rights of any subsequent transferee) to the assets are not affected by the insolvency or bankruptcy of the originator of the assets. Thus, the first transferee should be a special purpose entity and must have acquired the assets in a true sale. Broadly speaking, in case of bankruptcy of the originator (transferor) of the assets, unless there is a finding of a preferential transfer or fraudulent conveyance (and unless a subsidiary transferee is substantively consolidated with its transferor parent), a transfer that is a true sale cannot be voided or set aside and the assets will not be brought into the bankruptcy estate of the originator.

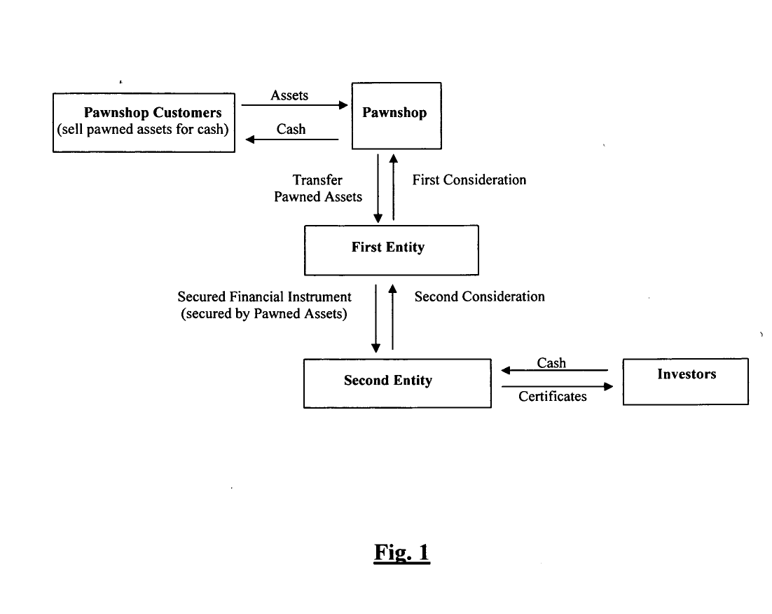

Turning now to the drawings to help further describe the invention, in FIG. 1, which shows a generalized system and method of this invention, pawnshop customers transfer assets for cash to the pawnshop, which is part of a pawnshop enterprise. The pawnshop transfers (e.g., sells in a true sale and/or contributes in a true contribution) at least some of the pawned assets, directly or indirectly, to a first entity for a first consideration, typically (but not necessarily) comprising three components: cash (the “advance rate”) in the amount of the second consideration, which would generally be an amount equal to or greater than the amount the pawnshop could obtain from traditional lending sources using the same pawned assets as security for a collateralized loan; an equity interest in the first entity (to the extent pawned assets of the pawnshop are contributed to capital of the first entity); and a subordinated note representing the difference between fair consideration for the pawned assets and the amounts paid in cash or contributed to capital. “Fair consideration” would reflect, among other things, the cost to the pawnshop of the pawned assets, the estimated total disposition value of the pawned assets, estimated average time for such assets to be redeemed or sold, and the estimated risk that some of the pawned assets will not be timely redeemed or sold for at least the estimated disposition value. The transfer is usually of the title to the pawned assets only; for convenience, possession of those pawned assets can remain with the pawnshop.

The first entity creates or issues (makes etc.) a secured financial instrument, which is secured by at least some of the pawned assets it received, directly or indirectly, from the pawnshop. The secured financial instrument is issued to a second entity for a second consideration, typically (but not necessarily) comprising an amount equal to the cash component of the first consideration. The second entity can obtain the funds necessary to pay the second consideration, directly or indirectly, from investors, in which case the investors may receive certificates (e.g., notes, commercial paper or other securities) evidencing their interest. (The term “certificate” should be broadly understood and refers to a document that contains facts of relevance to an investment, such as that the holder of the certificate is entitled to certain payments from an entity (e.g., a note) or is the owner of equity (e.g., a stock certificate) or is the owner of a trust interest in an entity (e.g., a trust certificate). In the present invention, the certificates issued to the investors will typically comprise asset-backed securities secured by the secured financial instrument and may take the form of notes, commercial paper, trust certificates, or any other form of asset-backed securities.)

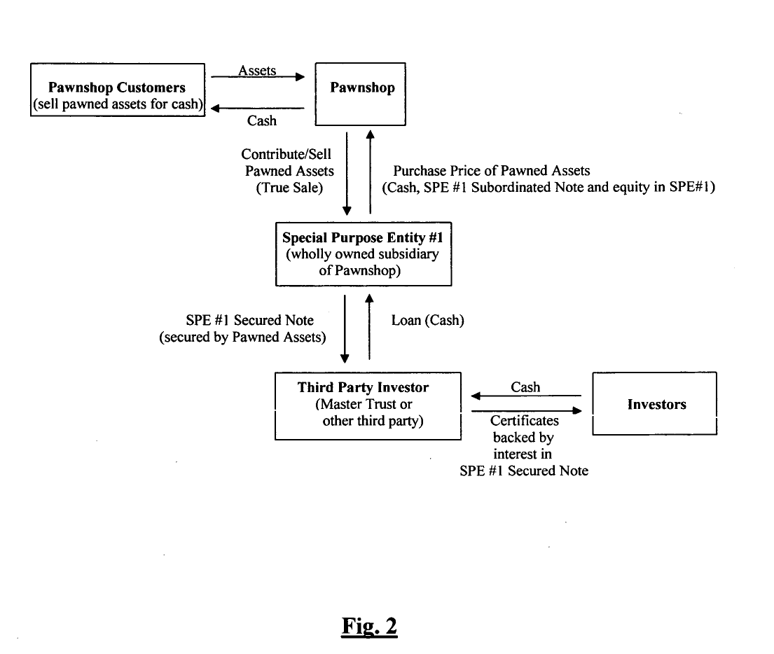

FIG. 2 shows the initial form of a specific structure and method for implementing the generalized system and method of FIG. 1. The transactions necessary to put in place the initial structure desirably would be treated as concurrent if doing so would be beneficial under the applicable laws (e.g., tax laws) or necessary to ensure that all transactions can occur and all conditions precedent have been satisfied (e.g., the first entity needs cash from the second entity to buy the assets from the pawnshop but it is a condition to the second entity's payment that the first entity own those assets).

The pawnshop directly or indirectly contributes (in a true contribution) and/or sells (in a true sale) at least some of the pawned assets to a first special purpose entity (SPE #1). SPE #1 is bankruptcy-remote. SPE #1, which corresponds to the first entity in FIG. 1, desirably is a wholly owned subsidiary of the pawnshop. All capital contributions referred to in this application are “true capital contributions” or “true contributions.” A “true capital contribution” or “true contribution” is a contribution to the capital of an entity made in accordance with applicable state or other law governing such contributions to capital. As indicated above, to support the “true sale” character of the transfer of assets, the price paid for them will have to represent fair consideration in view of all the facts and circumstances.

The third party investor (e.g., a master trust), which corresponds to the second entity in FIG. 1, makes a loan (advance) to SPE #1 and in return receives a promissory note made by SPE #1 that is secured by the pawned assets SPE #1 bought from the pawnshop. The secured note will typically be for the amount advanced, the risk of not being able to redeem or sell some of the pawned assets being taken into account, e.g., by over-collateralization (i.e., the note will be secured by pawned assets having a higher estimated total disposition value than the face amount of the note). Thus, SPE #1 will typically not initially receive enough cash as a loan from the third party investor to cover the entire pawned assets purchase price SPE #1 must pay to the pawnshop. The difference may be paid by SPE #1 to the pawnshop in the form of a subordinated note and/or some portion of the assets may be contributed to the capital of SPE #1 by the pawnshop rather than sold. The third party investor issues certificates backed by the secured financial instrument to investors in return for their cash investments. (As explained below, after the securitization is established and during the revolving period, the monies received by the pawnshop (as agent for SPE #1) from the redemptions and sales of the pawned assets will, in essence, be made available to the pawnshop by SPE #1 (generally in the form of payment of the purchase price for new assets) to allow the pawnshop to purchase newly pawned assets from its customers (which will be transferred to SPE #1 upon purchase).)

The pawned assets, which are physical assets, have now been securitized in accordance with the invention: the physical assets have been legally isolated from the insolvency risk of the transferor (the pawnshop); a financial asset (the secured note) that by its terms converts into cash within a finite period of time has been created and secured by the pawned assets; and certificates (e.g., securities) supported by the newly created financial asset (the secured financial instrument) have been issued by the third party investor and purchased by other investors.

In this embodiment, the physical (pawned) assets owned by SPE #1 and SPE #1's secured note will likely appear on the consolidated balance sheet of the pawnshop enterprise because SPE #1 is a wholly owned subsidiary of the pawnshop. However, because the pawned assets were sold by the pawnshop to SPE #1 in a true sale and/or contributed in a true contribution, the pawned assets (owned by SPE #1) should not be part of the bankruptcy estate of the pawnshop. That is important to the third party investor because the value of the security supporting the certificates depends on SPE #1 having good title, free and clear of all other interests, to the pawned assets. Having such title enables SPE #1 to transfer a valid security interest in the pawned assets to third parties (e.g., the third party investor), which provides the security needed to obtain the funding previously described.

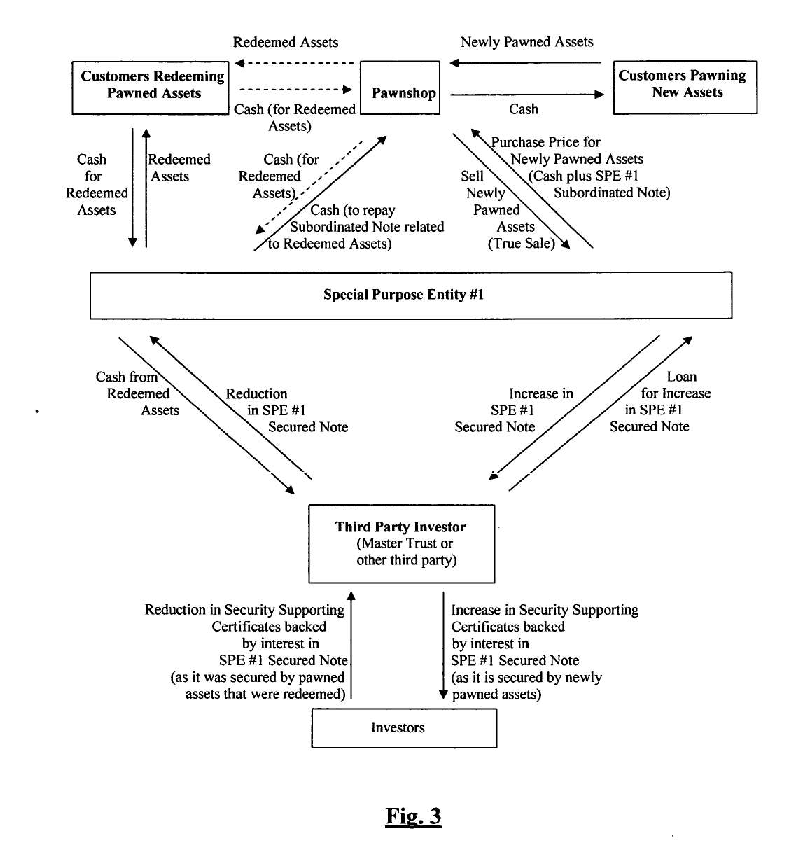

FIG. 3 shows what happens during the revolving period. The pawnshop receives cash from customers to redeem the pawned assets as agent for SPE #1, which owns the assets. Broadly speaking, in the drawings the dashed arrows indicate transfer of possession and the solid arrows indicate transfer of title (ownership). Thus, the dashed “cash” arrow between the customers redeeming pawned assets and the pawnshop, the dashed “cash” arrow between the pawnshop and SPE #1, and the solid “cash” arrow between those customers and SPE #1 indicate that the pawnshop is receiving that cash as agent for (on behalf of) SPE #1. Similarly, the dashed “redeemed assets” arrow between those customers and the pawnshop and the solid “redeemed assets” arrow between those customers and SPE #1 indicate that the pawnshop has possession of those pawned assets (which SPE #1 owns) and is transferring them to the customers as agent for (on behalf of) SPE #1.

At the same time these redemptions are occurring, customers are also pawning new assets and cash is being paid to them by the pawnshop. The newly pawned assets are sold in a true sale by the pawnshop to SPE #1, which pays a purchase price to the pawnshop, the price comprising cash and, if necessary, a new subordinated note or, more conveniently, an increase in the amount of the existing subordinated note.

Desirably, the notes and other documents establishing the transaction are written so that changes resulting from day-to-day pawnshop operations, e.g., increases or reductions in the amount due under each note and changes in any security for it (resulting from redemption of pawned assets and acquisition of new pawned assets, which often will not occur in equivalent amounts), do not require the actual physical transfer of such assets and the underlying documents do not have to be revised or redrafted. For example, grid notes would likely be used.

Pawned assets that have not been redeemed by their customers are likely to be sold to other parties during the revolving period. The flows for such sales (of assets, cash, rights, and obligations) are analogous to the flows for redemptions of pawned assets and, for the sake of simplicity, are not shown separately in FIG. 3.

As shown by the arrows between SPE #1 and the third party investor, cash from redeemed assets reduces the amount of the secured note (the secured financial instrument) and purchase of new pawned assets by the pawnshop results in an increase in the amount of the secured note and an increase in the loan made for it. At the same time, and as a result of these redemptions and purchases, the amount of the security backing the certificates held by the investors changes, as indicated by the arrows between them and the third party investor. Alternatively, cash from redeemed assets may have no effect on the amount of the secured note, but the pawned assets securing the secured note may shift over time as some assets are redeemed and the cash from such redemption is invested in new pawned assets.

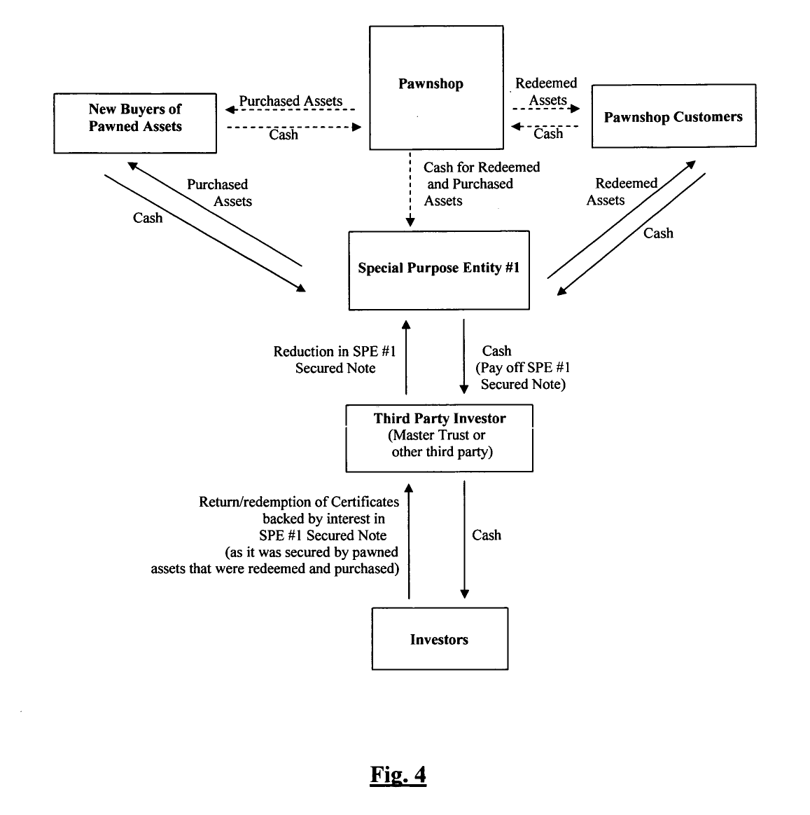

FIG. 4 shows the cash and other flows during the amortization (paydown) period up to the point SPE #1's secured note has been fully paid off by SPE #1. During this period, although the pawnshop may be operating, no new items are being purchased by SPE #1. In other words, the same pawnshop will still be in the business of purchasing pawned assets, but the agreements covering the current set of transactions do not cover the new pawns during this period and SPE #1 does not buy any additional pawned assets.

Cash is received by the pawnshop from redemptions by the customers of pawned assets and from sales to new buyers of unredeemed pawned assets. Conceptually, the cash from such redemptions and sales flows to SPE #1, which is the owner of the pawned assets, and then to the third party investor to reduce the outstanding (unpaid) balance on SPE #1's secured note, which the third party investor is holding. At the same time, title to the assets owned by SPE #1, which are redeemed or sold, flows to the pawnshop customers and the new buyers, and the security backing the secured note is reduced to the extent that security was provided by the pawned assets that have been redeemed and sold. (SPE #1's interest converts from an interest in pawned items to an interest in the cash for which they were sold, which interest in the cash flows to the third party investor.)

As before, the dashed arrows between the pawnshop and the new buyers/customers and between the pawnshop and SPE #1 plus the solid arrows between the new buyers/customers and SPE #1 indicate that the pawnshop as agent for SPE #1 is transferring the pawned assets (either by sale or redemption) and is receiving the cash.

Depending on the terms of the applicable agreements, after the third party investor is paid cash in the amount of the secured note, as well as accrued and unpaid interest and any remaining unpaid expenses of securitization, the certificates (e.g., securities) held by the investors are returned to the third party investor (redeemed or cancelled) and any undistributed cash is distributed to those investors in accordance with the terms of the certificates. The agreements may require redemption or payment of those certificates sooner due to a deficiency, either in the amount of principal paid on the secured note or in the level of monthly payments based on cash flow from the redeemed and/or sold pawned assets.

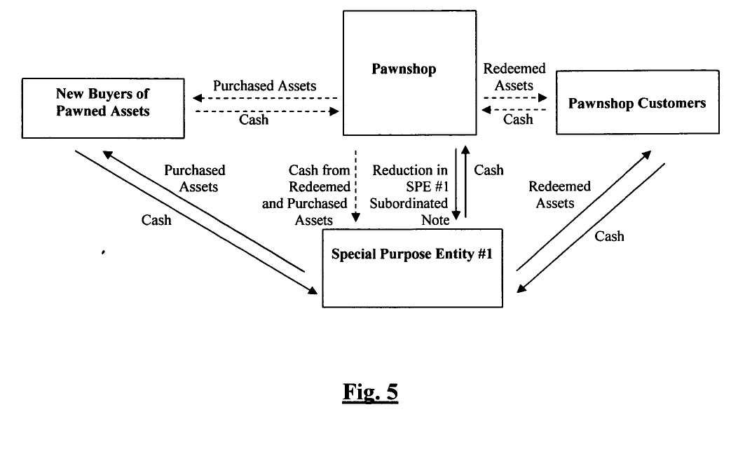

FIG. 5 shows the cash and other flows after all of those distributions and payments have been made. SPE #1 can now make payments on its subordinated note to the pawnshop. Conceptually, cash received by the pawnshop from the redemptions and sales to new buyers of pawned assets flows to SPE #1, which owns the pawned assets; title to those redeemed or sold assets passes from SPE #1 to the pawnshop's customers and new buyers; and the cash received by SPE #1 flows back to the pawnshop to pay off the SPE #1 subordinated note, which the pawnshop is holding. Once the subordinated note has been paid in full, including any accrued and unpaid interest and any other appropriate expenses, additional cash received by the pawnshop from redemptions and sales of the pawned assets flows to SPE #1 for its own account. The pawnshop benefits indirectly to the extent it owns the equity in SPE #1.

As a hypothetical example to illustrate the advantages of this embodiment of the invention, assume that in return for $1.9 million the pawnshop sells to and contributes to the capital of SPE #1 pawned assets having a total estimated disposition value of $2 million (for which the pawnshop paid $1 million). The pawnshop receives three assets totaling $1.9 million: $1 million cash; all of the equity of SPE #1; and a $0.2 million subordinated note. Assume the pawnshop's capital contribution consists of pawned assets with a total disposition value of $0.7 million, such that the pawnshop's equity interest in SPE #1 would be worth $0.7 million. In order to make the cash payment to the pawnshop, SPE #1 obtains $1 million in cash as a loan from a third party investor. To obtain the loan, SPE #1 issues to the third party investor a $1 million promissory note, secured by a security interest in the $2 million (the estimated disposition value) of pawned assets SPE #1 bought or received as a capital contribution from the pawnshop. The third party investor feels secure in making the $1 million loan because it is holding an over-collateralized promissory note (i.e., SPE #1's $1 million secured note backed by $2 million (the estimated disposition value) of pawned assets). In addition, the assets of SPE #1 are isolated from the creditors of the pawnshop since SPE #1 is structured and operated as a bankruptcy-remote entity that would not be substantively consolidated in a bankruptcy of the pawnshop.

As indicated, in return for the pawned assets (which cost the pawnshop $1 million) that the pawnshop sells and contributes to SPE #1, the pawnshop receives $1 million in cash immediately. The pawnshop eventually receives added payments as the subordinated note given to it by SPE #1 is paid off, which will not occur until the secured note has been paid in full and the pawned assets are either redeemed or sold by the pawnshop (acting as agent for SPE #1, which owns those assets). However, all cash proceeds received by SPE #1 during the revolving period will likely be paid to the pawnshop as the purchase price for new pawned assets. Cash received by SPE #1 in respect of its capital may be loaned by SPE #1 to the pawnshop or distributed to the pawnshop as a return of capital.

Compared to a more conventional commercial bank borrowing, that, for example, has an interest rate of Prime (the prime rate) plus 3% and an advance (loan) rate of 50% to 80% of the pawnshop's cost of $1 million, the invention is believed to provide the following advantages: (1) a likely lower cost of funds (at Prime plus 1%, for example, compared to Prime plus 3%). The reason for the lower rate is, among other things, that the risk profile related to the collateral (the pawned assets) has been upgraded because the pawned assets are isolated from insolvency risk of the pawnshop; (2) a likely higher advance rate providing additional funding for the pawnshop (in this example, 100% of the pawnshop's cost versus an estimated 50% to 80% of the pawnshop's cost); and (3) possible diversification of the pawnshop's finding sources since the securitization lenders are typically different from traditional commercial banking lenders.

The inventors believe that in most cases the pawnshop's cost of financing obtained through use of the method and system of this invention will be less than the cost from traditional lending sources and/or that the pawnshop will be able to borrow greater amounts. Furthermore, if the pawnshop performs well (i.e., the pawned assets are redeemed and sold for $2 million or more, which should occur if the total disposition value of the pawned assets is estimated conservatively), the pawnshop will benefit because SPE #1, which owns the pawned assets in this example and receives all of the excess monies from redemption and sale, is a wholly owned subsidiary of the pawnshop.

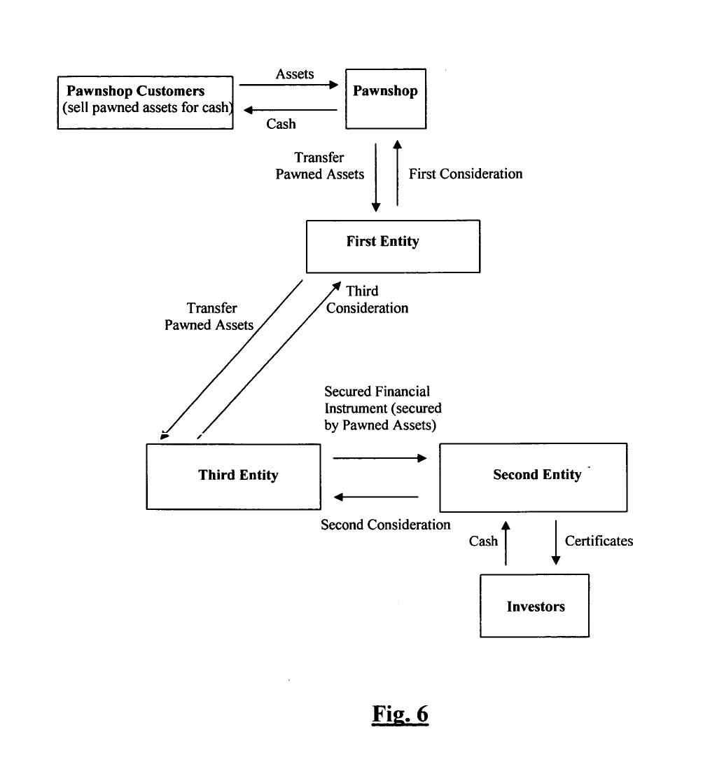

FIG. 6 shows another generalized system and method of this invention. In contrast to the system and method of FIG. 1, it is believed that the system and method shown in FIG. 6 will, under current generally accepted accounting principles (“GAAP”), remove the securitized assets and related debt from the consolidated financial statements of a pawnshop. The difference between the generalized systems of FIG. 6 and FIG. 1 is the addition to the FIG. 6 system of a third entity, which purchases the pawned assets from the first entity for a third consideration. The third entity then borrows money from the second entity (the second consideration) in return for a secured financial instrument (secured by the pawned assets).

In this system, pawnshop customers transfer assets for cash to the pawnshop. The pawnshop sells and/or contributes to capital at least some of the pawned assets directly or indirectly to the first entity for the first consideration, typically (but not necessarily) comprising cash, a note, and an equity interest in the first entity. The transfer is usually of title to the pawned assets only; for convenience, possession of those pawned assets can remain with the pawnshop.

The first entity sells at least some of the pawned assets directly or indirectly to the third entity for the third consideration. The second transfer is usually of title to the pawned assets only; for convenience, possession of those pawned assets can remain with the pawnshop. The third consideration is typically a combination of cash and a secured financial instrument (e.g., a note) that the third entity creates or issues (makes etc.), and the instrument is secured by at least some of the pawned assets the third entity received, directly or indirectly, from the first entity. However, the secured financial instrument given to the first entity will usually be subordinated to a more senior secured loan that the third entity obtains from the second entity.

The third entity obtains the second consideration (typically a loan in the form of cash and/or possibly a note) from the second entity in return for a secured financial instrument that is secured by at least some of the pawned assets the third entity received, directly or indirectly, from the first entity. The second entity can obtain the funds necessary to pay the cash constituting the second consideration, directly or indirectly, from investors, in which case the investors may receive certificates (e.g., notes, commercial paper, or other securities) evidencing their interest.

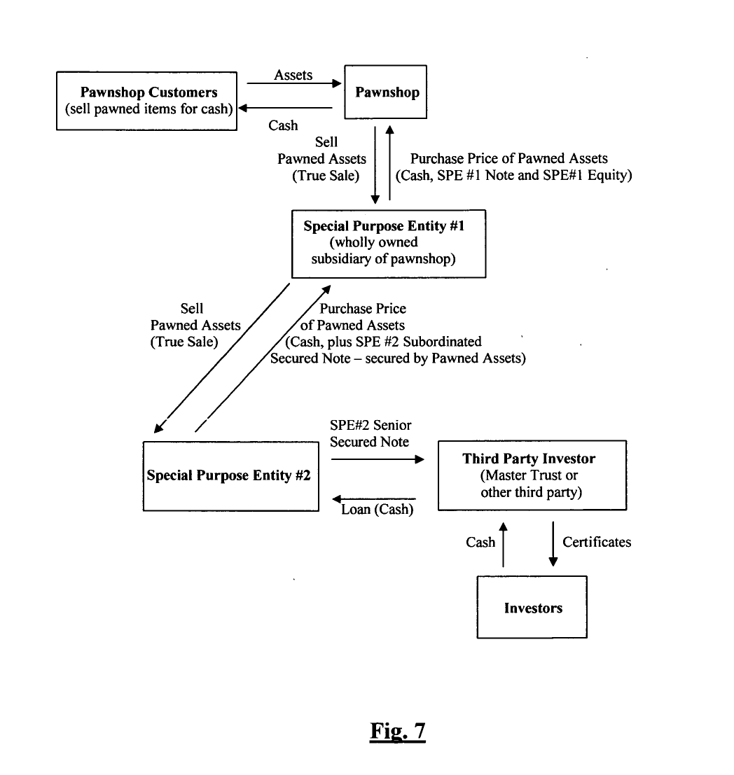

FIG. 7 shows the initial form of a specific structure and method for implementing the generalized system and method of FIG. 6. The transactions necessary to put in place the initial structure desirably would be treated as concurrent if doing so would be beneficial under the applicable laws (e.g., tax laws) or necessary to ensure that all transactions can occur and all conditions precedent have been satisfied (e.g., the first entity needs cash from the third entity to buy the assets from the pawnshop, while the third entity will need to obtain a loan from the second entity to obtain the cash needed to buy the assets from the first entity, but it is a condition to the second entity's payment that the third entity own such assets).

The pawnshop contributes to capital and/or sells, directly or indirectly, at least some of the pawned assets to a first special purpose entity (SPE #1) in a true sale and/or a true contribution. SPE #1 is bankruptcy-remote and corresponds to the first entity in FIG. 6. SPE #1 desirably is a wholly owned subsidiary of the pawnshop. For assets that are not contributed, SPE #1, directly or indirectly, pays to the pawnshop a purchase price comprising cash plus a note. The pawnshop can use this cash to make payments to its customers pawning assets.

SPE #1, directly or indirectly, sells at least some of the pawned assets transferred to it to a second special purpose entity (SPE #2) in a true sale. SPE #2 is also bankruptcy-remote and corresponds to the third entity in FIG. 6. The purchase price for the pawned assets SPE #2 buys is paid, directly or indirectly, to SPE #1 and consists of two components: cash and a note created or issued (e.g., made) by SPE #2 and secured by the pawned assets SPE #2 purchased from SPE #1 (the “SPE #2 Subordinated Secured Note”). The SPE #2 Subordinated Secured Note will be subordinated to the “SPE #2 Senior Secured Note” described below.

The face amount of the SPE #2 Secured Subordinated Note will be determined by negotiations between SPE #1 and SPE #2 and, in order to support the true sale character of the transfer of the pawned assets, when added to the cash consideration paid for the assets, should be fair consideration. The determination of fair consideration will take into account a number of factors, including, but not limited to, the amount of cash paid by SPE #2 to SPE #1, the cost to the pawnshop of the pawned assets, the estimated total disposition value of the pawned assets securing the secured note, estimated average time for such assets to be redeemed or sold, and the estimated risk that some of the pawned assets will not be timely redeemed or sold for at least the estimated disposition value. As indicated above, the estimated disposition value may be determined using many different tools and sources, including automated proprietary valuation systems, catalogues, “blue books,” newspapers, internet research, and the previous disposition experience of the pawnshop involved.

SPE #2, directly or indirectly, obtains a loan from the third party investor (e.g., a master trust), which corresponds to the second entity in FIG. 6. The loan will be evidenced by a note secured by a security interest in some or all of the pawned assets purchased from SPE #1 (the “SPE #2 Senior Secured Note”) and will, in many but not all cases, also be secured by pawned assets purchased directly or indirectly from other pawnshops (e.g., through special purpose entities purchasing such pawned assets from other pawnshops). All of those pawnshops together may be considered to be a pawnshop enterprise, in accordance with the definition of “pawnshop enterprise” (above). The loan amount will be negotiated by the parties. The amount of the loan made by the third party investor to SPE #2 will typically be less (and sometimes significantly less) than the purchase price paid for the pawned assets by SPE #2. The amount of the loan and the difference between the loan amount and the purchase price paid by SPE #2 will depend in part on the degree of any over-collateralization of the SPE #2 Senior Secured Note necessary to support required ratings and any other credit enhancements. (Over-collateralization occurs, for example, when the pawned assets securing the note have a higher estimated total disposition value than the face amount of the note.)

The third party investor obtains the cash for the loan it will make to SPE #2 from the various entities (natural and juridical persons—the investors) who make investments in, e.g., a trust or other vehicle, and in return receive certificates (e.g., notes, commercial paper, or other securities) evidencing their investment.

The pawned assets, which are physical assets, have now been securitized in accordance with the invention: the physical assets have been legally isolated from the insolvency risk of the pawnshop; a financial asset (SPE #2's Senior Secured Note) secured by the pawned assets has been created; and certificates (e.g., securities) supported by the newly created financial assets have been issued by a third party investor and purchased by other investors. Because the pawned assets were sold by the pawnshop to SPE #1 in a true sale and then resold by SPE #1 to SPE #2 in a true sale, the pawned assets (now owned by SPE #2) should not be part of the bankruptcy estate of the pawnshop. This protection is important to the third party investor (and the investors holding the certificates) because the value of the certificates depends on SPE #2 having good title, free and clear, to the pawned assets. Having such title enables SPE #2 to transfer or grant a valid security interest in the pawned assets to the third party investor, which provides the collateral needed to obtain the funding previously described. Furthermore, because the sale of the pawned assets by SPE #1 to SPE #2 was in compliance with the applicable sale treatment principles (i.e., was a true sale or a true contribution and so long as SPE #1 was not the “primary beneficiary” of SPE #2 for purposes of Fin 46(R)), the cash received from the sale, the equity in SPE #1, and the SPE #2 Subordinated Secured Note should be reflected on the consolidated financial statements of the pawnshop enterprise, while the pawned assets and any financing obtained by SPE #2 from the third party investor (and evidenced by the SPE #2 Senior Secured Note) should not appear on the consolidated financial statements of the pawnshop enterprise, other than through a footnote explaining the transactions.

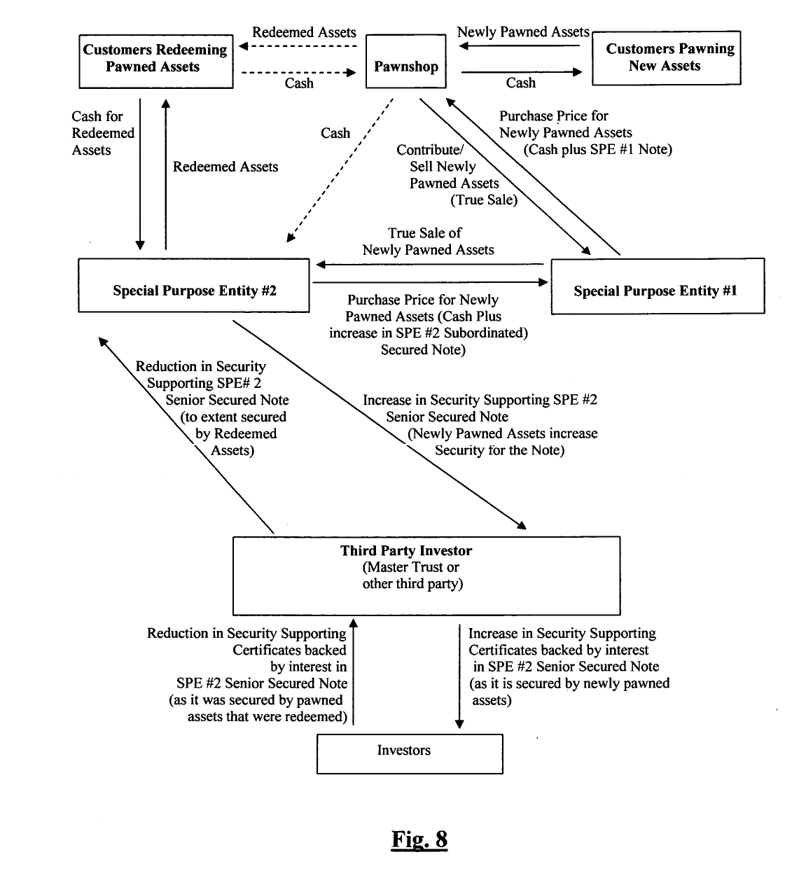

FIG. 8 shows conceptually what happens during the revolving period, i.e., the period during which pawned assets that have already been securitized are redeemed or sold and new assets are pawned, i.e., purchased by the pawnshop.

As shown in FIG. 8, during the revolving period, the pawnshop receives cash from customers to redeem or purchase the pawned assets, and this cash is received by the pawnshop on behalf of (as agent for) SPE #2, which owns the pawned assets. (Pawned assets that have not been redeemed by their customers are likely to be sold by the pawnshop to other parties during the revolving period. The flows for such sales (of assets, cash, rights, and obligations) and effect on the value of the certificates are analogous to the flows and effect for redemptions of pawned assets and, for the sake of simplicity, are not shown in FIG. 8.) Title to the redeemed or purchased pawned assets flows from SPE #2 to the customer redeeming or buying the pawned asset in exchange for a cash payment. The cash received by the pawnshop from redemptions and sales is treated as being paid by the pawnshop to SPE #2, which reinvests the cash in new pawned assets. (As before, the dashed and solid arrows for the assets and cash flows indicate that the pawnshop is acting as agent for SPE #2.)

As shown in FIG. 8, during the revolving period, customers are also pawning new assets, and cash is being loaned to those customers by the pawnshop. In order to enable the pawnshop to continue the securitization process for the newly pawned assets, these newly pawned assets are sold in a true sale by the pawnshop to SPE #1, which pays a purchase price to the pawnshop, the price comprising cash and, if necessary, a new note or, more conveniently, an increase in the amount of the existing SPE #1 note. Those newly pawned assets are then sold in a true sale by SPE #1 to SPE #2, the purchase price usually consisting of cash and, if necessary, an increase in the amount due under the SPE #2 Subordinated Secured Note. All parties benefit: the pawnshop can continue to purchase pawned assets using the cash provided by the third party investor to SPE #2, which, in turn, provides it to SPE #1, which in turn provides it to the pawnshop; the third party investor continues to obtain a return on its investment without the need to enter into a new securitization; and the owners of SPE #2 usually obtain additional compensation for purchasing the additional pawned items.

On any given day (or other time period), the net flow of cash between each pair of parties (e.g., the third party investor and SPE #2, SPE #2 and SPE #1, SPE #1 and the pawnshop, the pawnshop and SPE #2) may be in either direction, depending on total value of the particular assets redeemed or sold and total value of the newly pawned assets purchased that day (or other time period).

Desirably, the notes and other documents creating the structure are written so that changes resulting from day-to-day pawnshop operations, e.g., increases or reductions in the amount of the secured notes and changes in the security for them (resulting from redemption or sale of pawned assets and acquisition of new pawned assets), do not result in the physical transfer of pawned assets, the daily movement of funds, or the revision or redraft of the notes and other documents.

One or more bank accounts desirably are used to hold and net out the daily cash flows, with one of them (e.g., a lockbox account) established to receive the pawnshop's redemption receipts in the name of SPE #2 (which owns the pawned assets), which are typically paid, in part or in whole, to SPE #1, which, in turn, uses such cash to purchase newly pawned assets from the pawnshop. During the revolving period, except in the case of a significant decline in the value of pawned assets, it is unlikely that cash will be used to repay principal of the SPE #2 Senior Secured Note to the third party investor or remain with SPE #2.

The agreements between the third party investor and the investors may specify the date on or conditions upon which investors' certificates must be partially or totally paid or redeemed (e.g., the date the revolving period ends). In the interim (i.e., after issuance of the certificates and prior to any redemption of such certificates), the security for the certificates, which is based on the value of the pawned assets securing the SPE #2 Senior Secured Note plus any cash received by the third party investor in repayment of the senior secured notes, will vary but should remain approximately constant since for a given time period, the value of pawned assets sold or redeemed should be approximately the same as the value of newly purchased assets acquired by the pawnshop and transferred to SPE #1 and then to SPE #2.

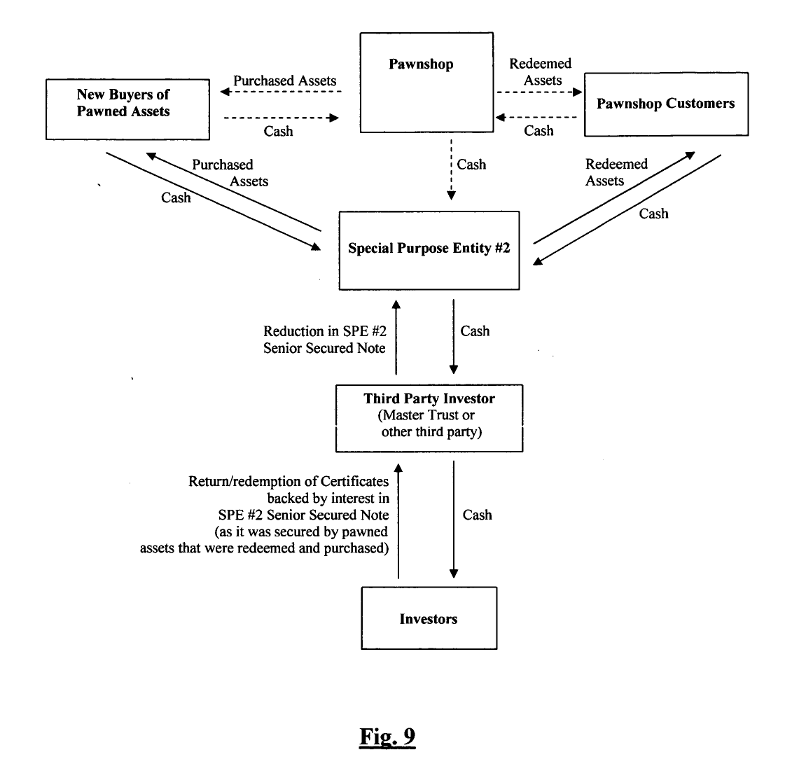

FIG. 9 shows for the amortization (paydown) period the cash and other flows before the SPE #2 Senior Secured Note held by the third party investor has been fully repaid by SPE #2, before the SPE #2 Subordinated Secured Note held by SPE #1 has been fully repaid by SPE #2, and before SPE #1 pays off its note held by the pawnshop. During the amortization period, no new assets are being transferred to SPE #1 and through SPE #1 to SPE #2. More specifically, although the pawnshop may be operating, it either is not accepting any new pawned assets (and therefore is not making payments based on them) or it is accepting pawns and making payments, but those are not part of the current set of transactions being implemented using the method of this invention. In other words, the same pawnshop may be in business, but the agreements covering the current set of transactions do not cover the new pawned assets and SPE #1 and SPE #2 do not buy any of these new pawned assets.

During this period, cash is received by the pawnshop, as agent for SPE #2, for redemptions by the customers of pawned assets and for sales to buyers of unredeemed pawned assets. Conceptually, cash received by the pawnshop, as agent, from the redemption and sale to new buyers of pawned assets flows to SPE #2, which is the owner of the pawned assets, and then is paid by SPE #2 to the third party investor to reduce the unpaid balance on the SPE #2 Senior Secured Note, which the third party investor owns. At the same time, title to the assets owned by SPE #2 flows to the pawnshop customers and to the new buyers in exchange for the cash payments, and the security backing the SPE #2 Senior Secured Note is reduced to the extent that security was provided by the pawned assets that have been redeemed and sold. Cash received by the third party investor is paid to the investors in accordance with the terms of their investments. Depending on the provisions of the agreements implementing this system and method of the invention, SPE #2 may be required to start repaying some portion of its SPE #2 Subordinated Secured Note held by SPE #1 before SPE #2 has paid all amounts due on its SPE #2 Senior Secured Note held by the third party investor. For example, the agreements may require SPE #2 to repay some portion of its Subordinated Secured Note when and if a specified principal percentage of its Senior Secured Note has been repaid.

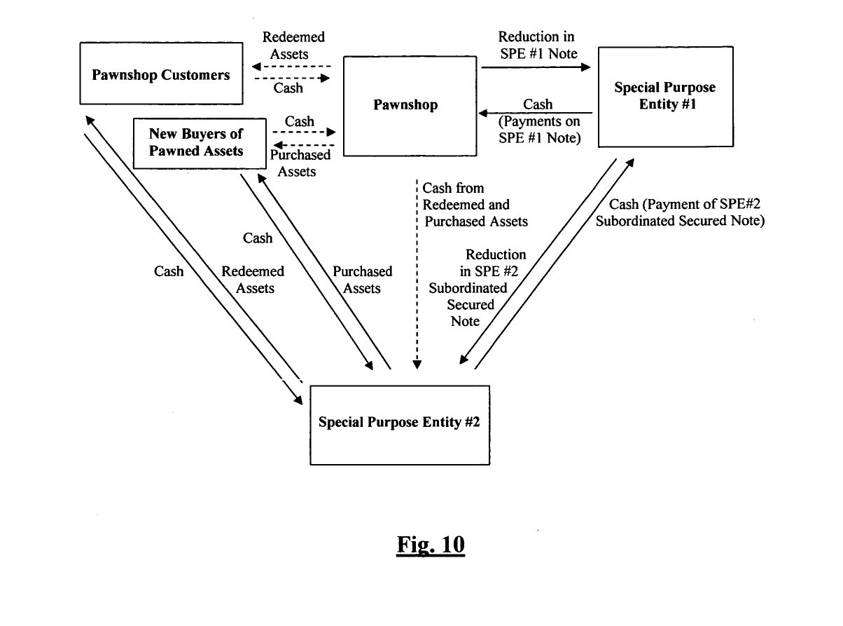

FIG. 10 shows for the amortization period the cash and other flows when the cash flow is sufficient for SPE #2 to pay the amounts due on its SPE #2 Subordinated Secured Note issued to SPE #1 as part of the consideration for the pawned assets (the Senior Secured Note may or may not have been fully paid off at this point, depending on the specifics of the arrangement). During this period, cash continues to be received by the pawnshop, as agent, from redemptions by the customers of pawned assets and for sales to new buyers of unredeemed pawned assets. The cash received flows to SPE #2, which is the owner of the pawned assets, and then is paid by SPE #2 to SPE #1 to reduce the unpaid balance on the SPE #2 Subordinated Secured Note. SPE #1 uses such payments to reduce its note obligations to the pawnshop and may also return capital to the pawnshop. At the same time, title to the pawned assets owned by SPE #2 flows to the pawnshop customers and to the new buyers, and the security backing the SPE #2 Subordinated Secured Note is reduced to the extent that security was provided by the pawned assets that have been redeemed and sold (as noted above, the unpaid balance on that note is also being reduced by the cash payments made by SPE #2 to SPE #1).

If the assets perform as expected, eventually enough cash flows from the pawnshop to SPE #2 to the third party investor, and from the pawnshop to SPE #2 to SPE #1 to the pawnshop, to pay off the SPE #2 Senior Secured Note, the SPE #2 Subordinated Secured Note, and SPE #1's note.

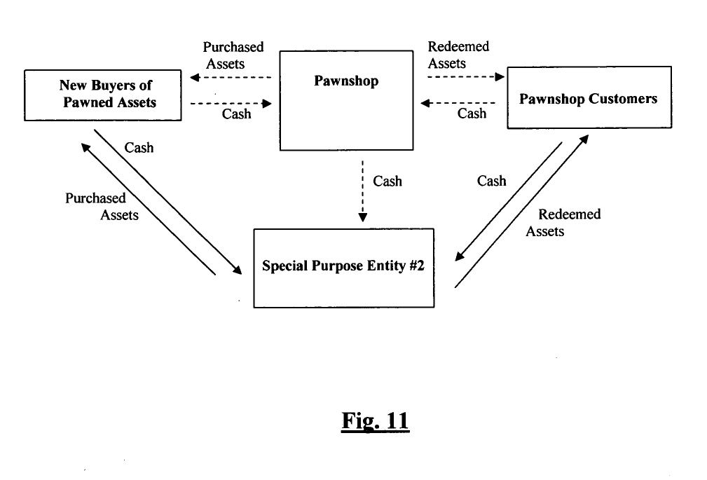

FIG. 11 shows for the amortization period the cash and other flows after the SPE #2 Senior Secured Note, the SPE #2 Subordinated Secured Note, and SPE #1's note have been repaid. Any cash received by the pawnshop from redemptions by the customers of pawned assets and for sales to new buyers of unredeemed pawned assets flows to SPE #2, which is still the owner of the pawned assets, and title to the assets owned by SPE #2 flows to the pawnshop customers and the new buyers (the pawnshop is still acting as agent for SPE #2). Because SPE #2's senior and subordinated notes and all related expenses have been paid in full, additional cash received by the pawnshop from the redemption and sale of the pawned assets flows to SPE #2 for its own account, which is one way that SPE #2 makes a profit for its owner.

SPE #2 will usually engage in the same process with a number of pawnshops (or enterprises), so that it will be able to aggregate a sufficient amount of assets to be able to economically engage in a securitization. As a result, SPE #2 will own pawned assets purchased from one or more different pawnshops (or pawnshop enterprises) and will have issued one or more subordinated notes with respect to one or more of such pawnshops.

As a hypothetical example to illustrate the advantages of this embodiment of the invention, assume the pawnshop sells to SPE #1 (the first entity in FIG. 6) and contributes to the capital of SPE #1 pawned assets purchased by the pawnshop for $1 million (and having a total estimated disposition value of $2 million) for a total consideration of $1.9 million. Assume the capital contribution (equity in SPE #1) consists of pawned assets with a total disposition value of $0.7 million and the remaining consideration comprises $1 million in cash plus $0.2 million in a note, for the total of $1.9 million. SPE #1, in turn, sells the pawned assets to SPE #2 (the third entity in FIG. 6) for a total of $1.9 million, consisting of $1 million in cash and a subordinated secured note for $0.9 million created or issued (e.g., made) by SPE #2 and secured by the pawned assets having a disposition value of $2 million. (The security interest held by SPE #1 is subordinate to the security interest held by the third party investor, as described below.) SPE #2 obtains a loan from a third party investor (the second entity in FIG. 6) for $1 million in cash. The loan is evidenced by a senior secured note (with a face amount of $1 million) created or issued (e.g., made) by SPE #2 and secured by a security interest in the pawned assets having an estimated disposition value of $2 million. This senior security interest held by the third party investor has a priority over the subordinated security interest held by SPE #1.

From the pawnshop's perspective, it has sold and/or contributed pawned assets with an expected disposition value of $2 million and received three assets in return: $1 million in cash; all of the equity of SPE #1 ($0.7 million); and SPE #1's $0.2 million note. SPE #1 has, in turn, received $1 million in cash and $0.9 million in the form of a subordinated secured note from SPE #2. SPE #2, in turn, has borrowed $1 million from the third party investor using the pawned assets as security. SPE #2's primary source of funds to repay both its senior note and its subordinated note will be the proceeds from the sale and/or redemption of the pawned assets it purchased and owns. SPE #1's primary source of funds to repay its note to the pawnshop will be from the payment by SPE #2 of its subordinated secured note. The pawnshop expects SPE #2 to pay off the $0.9 million subordinated secured note issued to SPE #1 (since such payments are a function solely of the redemption and sale of the pawned assets in amounts consistent with the pawnshop's historical practice), and, as a result, the pawnshop expects to and should receive payment in full of the $0.2 million subordinated note it is holding and $0.7 million for its equity interest in SPE #1.

As a result of the invention, the pawnshop would likely obtain more favorable rates than if it used traditional financing methods. In addition, a traditional lending source would probably loan funds to the pawnshop, secured by the pawned assets, based on a percentage, often substantially less than 100%, of the actual cost to the pawnshop of the pawned assets, i.e., less than the $1 million in the example. The inventors believe that in most cases, the pawnshop's cost of obtaining funding through securitizations according to this invention will be less than the cost from traditional lending sources and/or that the pawnshop will be able to borrow greater amounts. Furthermore, in the example, the consolidated financial statement of the pawnshop enterprise, for financial reporting purposes, should not include the SPE #2 Senior Secured Note held by the third party investor as a liability, should not include the pawned assets sold to SPE #1 and then to SPE #2 as an asset, but should include, as assets, the pawnshop's equity interest in SPE #1, the SPE #2 Subordinated Secured Note (which SPE #1 is holding), and the $1 million in cash it received. The net result should be a stronger financial statement, which, in turn, may help lower the pawnshop's borrowing costs from traditional lenders and/or allow it to obtain more funding than it would otherwise be able to obtain, which can then be used by it to purchase more pawned assets and/or for any other enterprise purpose.

From the third party investor's perspective, it has made a safe investment and received a reasonable return (the interest on the secured note). It loaned $1 million and received a note secured by assets with an expected disposition value of $2 million.

From SPE #2's perspective, it used two promissory notes aggregating $1.9 million to purchase pawned assets with an estimated disposition value of $2 million, $0.1 million more than the face amount of the notes, which gives it an expectation that it would likely not lose money and should also compensate it for making the investment.

This analysis ignores the time value of money, i.e., the obligation to make interest payments on the face amounts of the secured notes and the length of time it will take for the pawned assets to be redeemed or sold, for which the parties will adjust through a further decrease in the purchase price paid by SPE #1 to the pawnshop, and by SPE #2 to SPE #1, for the pawned assets. Furthermore, because SPE #2 is the owner of the pawned assets, after it pays off the secured notes, the income from any further redemption and sale of the pawned assets above the $1.9 million is solely for its own account, although some of this income will be used to cover the costs of borrowing from the third party investor.

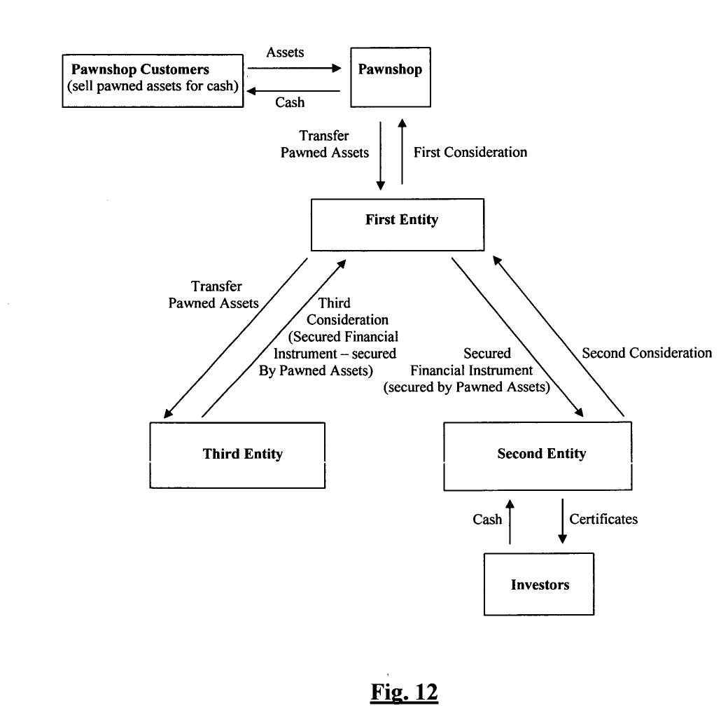

FIG. 12 shows another generalized system and method of this invention. In contrast to the system and method of FIG. 1, it is believed that the system and method shown in FIG. 12 may, under current generally accepted accounting principles (“GAAP”), remove the securitized assets and related debt from the consolidated financial statements of a pawnshop. However, this generalized system and method will be effective to enable securitizations according to this invention to occur and obtain one or more of its benefits, whether or not this system and method remove the securitized assets and related debt from the consolidated financial statements.

The difference between the generalized systems and methods of FIG. 12 and FIG. 1 is the addition to the FIG. 12 system of a third entity, which gives a third consideration to the first entity for the pawned assets it receives from the first entity. The first entity then transfers some or all of the third consideration to the second entity in return for the second consideration.

The difference between the generalized systems and methods of FIG. 12 and FIG. 6 is the difference in the relationship between the second and third entities. In both FIGS. 6 and 12, the first entity transfers the pawned assets to the third entity. In FIG. 6, the third entity issues a financial instrument to the second entity secured by the pawned assets but in FIG. 12, the third entity issues the secured financial instrument to the first entity and the first entity transfers it to the second entity.

In the system and method of FIG. 12, pawnshop customers transfer assets for cash to the pawnshop. The pawnshop sells to the first entity, and/or contributes to capital of the first entity, at least some of the pawned assets for the first consideration, typically (but not necessarily) comprising cash, a note, and an equity interest in the first entity. The transfer is usually of title to the pawned assets only; for convenience, possession of those pawned assets can remain with the pawnshop. The first entity sells at least some of the pawned assets directly or indirectly to the third entity for the third consideration. The second transfer is usually of title to the pawned assets only; for convenience, possession of those pawned assets can remain with the pawnshop.

The third consideration comprises a secured financial instrument that the third entity creates or issues (e.g., makes), and the instrument is secured by at least some of the pawned assets the third entity received, directly or indirectly, from the first entity (the third consideration may also comprise cash and/or deferred purchase price). The secured financial instrument is, in turn, transferred, directly or indirectly, by the first entity to the second entity for the second consideration, typically (but not necessarily) comprising both cash and a deferred purchase price (which may or may not be evidenced by a contingent note). The second entity can obtain the funds necessary to pay the cash component of the second consideration, directly or indirectly, from investors, in which case the investors may receive certificates (e.g., notes, commercial paper, or other securities) evidencing their interest.

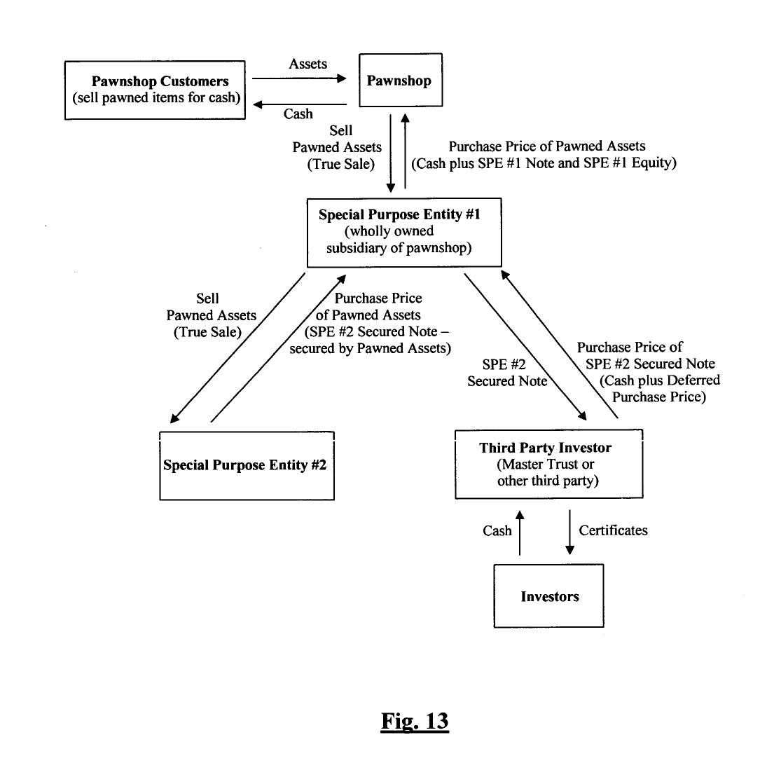

FIG. 13 shows the initial form of a specific structure and method for implementing the generalized system and method of FIG. 13. The transactions necessary to put in place the initial structure desirably would be treated as concurrent if doing so would be beneficial under the applicable laws (e.g., tax laws) or necessary to ensure that all transactions can occur and all conditions precedent have been satisfied (e.g., the first entity needs cash from the second entity to buy the assets from the pawnshop but it is a condition to the second entity's payment that the third entity own the assets).

The pawnshop contributes capital to, and/or sells, directly or indirectly, at least some of the pawned assets to a first special purpose entity (SPE #1) in a true sale and/or a true contribution. SPE #1 is bankruptcy-remote and corresponds to the first entity in FIG. 12. SPE #1 desirably is a wholly owned subsidiary of the pawnshop. For assets that are not contributed, SPE #1, directly or indirectly, pays to the pawnshop a purchase price comprising cash plus a note. The pawnshop can use this cash to make payments to its customers pawning assets.

SPE #1, directly or indirectly, sells at least some of the pawned assets to a second special purpose entity (SPE #2) in a true sale. SPE #2 is also bankruptcy-remote and corresponds to the third entity in FIG. 12. The purchase price for the pawned assets SPE #2 buys is paid, directly or indirectly, to SPE #1 using a secured financial instrument, a note created or issued (e.g., made) by SPE #2 and secured by all of the pawned assets purchased by SPE #2 from SPE #1 (the “SPE #2 Secured Note”).

The face amount of the SPE #2 Secured Note will be determined by negotiations between SPE #1 and SPE #2 and should be for fair consideration that takes into account a number of factors, including, but not limited to, the cost to the pawnshop of the pawned assets, the estimated total disposition value of the pawned assets securing the secured note, estimated average time for such assets to be redeemed or sold, and the estimated risk that some of the pawned assets will not be timely redeemed or sold for at least the estimated disposition value. As indicated above, the estimated disposition value may be determined using many different tools and sources, including automated proprietary valuation systems, catalogues, “blue books,” newspapers, internet research, and the previous disposition experience of the pawnshop involved. The secured note may be made more marketable using a credit enhancement such as over-collateralization (i.e., the pawned assets securing the note having a higher estimated total disposition value than the face amount of the note). In any case, as indicated above, to support the true sale character of the transfer of pawned assets, the price paid for them (the size of the note) will have to be a fair consideration.

The third party investor (e.g., a master trust), which corresponds to the second entity in FIG. 12, buys the SPE #2 Secured Note, which is now owned by SPE #1, for a second consideration (the purchase price) negotiated by the parties. The parties will also negotiate the proportion of the total purchase price to be paid in cash immediately rather than deferred or made contingent upon sale of the pawned assets. Thus, the cash portion of the purchase price paid by the third party investor will typically be less (and sometimes significantly less) than the face amount of the SPE #2 Secured Note. The discount will depend in part on the degree of any over-collateralization of the secured note and any other credit enhancements.

The third party investor obtains the cash portion of the purchase price it will pay SPE #1 for the SPE #2 Secured Note from the various entities (natural and juridical persons—the investors) who make investments in, e.g., a trust or other vehicle, and in return receive certificates (e.g., notes, commercial paper, or other securities) evidencing their investment. As previously noted and as further described below, the deferred portion of the purchase price for the SPE #2 Secured Note will be paid by the third party investor to SPE #1 only if the performance of the pawnshop (in redemption and sale of pawned assets) generates sufficient funds to permit such payment.

The pawned assets, which are physical assets, have now been securitized in accordance with the invention: the physical assets have been legally isolated from the insolvency risk of the pawnshop; a financial asset secured by the pawned assets has been created; and certificates (or other securities) supported by the newly created financial assets have been issued by a third party investor and purchased by other investors. Because the pawned assets were sold by the pawnshop to SPE #1 in a true sale and then resold by SPE #1 to SPE #2 in a true sale, the pawned assets (owned by SPE #2) should not be part of the bankruptcy estate of the pawnshop. That is important to the third party investor because the value of the certificates it issues to investors depends on SPE #2 having good title, free and clear, to the pawned assets. Having such title enables SPE #2 to transfer or grant a valid security interest in the pawned assets to the third party investor (by way of assignment from SPE #1), which provides the security needed to obtain the funding previously described. Furthermore, to the extent the sale of the secured note by SPE #1 to the third party investor and the transfer of the pawned assets from SPE #1 to SPE #2 are in compliance with applicable sale treatment principles, the secured note and related obligations, as well as the pawned assets, have been removed from the consolidated financial statements of the pawnshop enterprise. In such circumstances, neither the pawned assets, which are now owned by SPE #2, nor SPE #2's secured note, which is now owned by the third party investor, should appear on the consolidated balance sheet of the pawnshop enterprise.

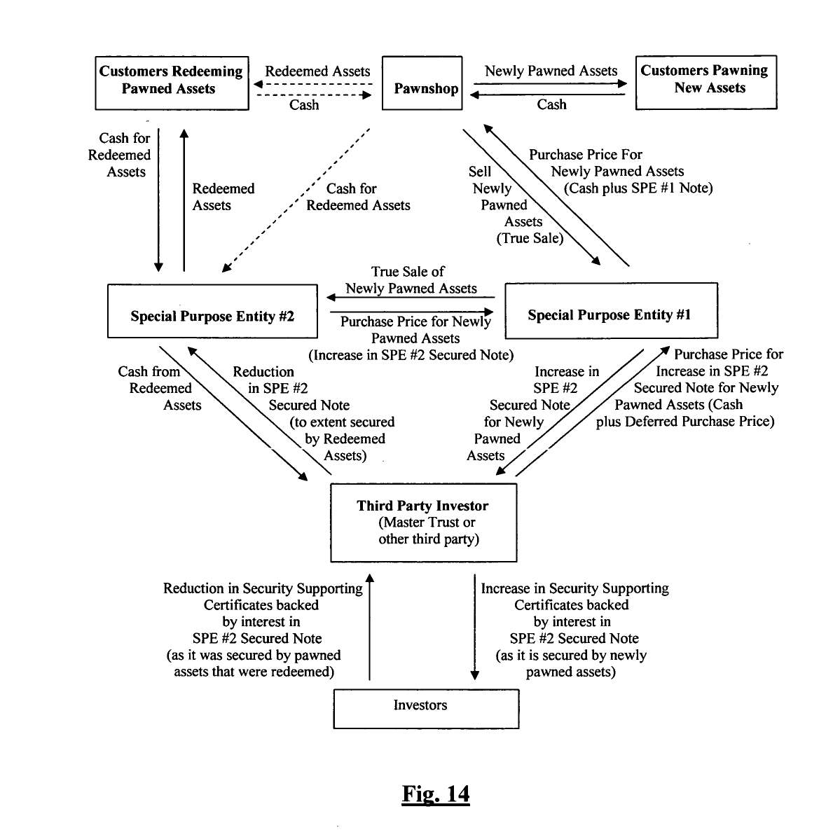

FIG. 14 shows conceptually what happens during the revolving period, i.e., the period during which pawned assets that have already been securitized are redeemed or sold and new assets are pawned, i.e., purchased by the pawnshop.

During the revolving period, the pawnshop receives cash from customers to redeem the pawned assets, and this cash is received by the pawnshop on behalf of (as agent for) SPE #2, which owns the pawned assets. (Pawned assets that have not been redeemed by their customers are likely to be sold by the pawnshop to other parties during the revolving period. The flows for such sales (of assets, cash, rights, and obligations) and effect on the value of the certificates are analogous to the flows and effect for redemptions of pawned assets and, for the sake of simplicity, are not shown in FIG. 14.) Title to the redeemed pawned assets flows from SPE #2 to the customer redeeming or buying the pawned asset in exchange for cash payments. The cash received by the pawnshop from redemptions and sales is treated as being paid by the pawnshop to SPE #2 and by SPE #2 to the third party investor or, alternatively, as being reinvested in new pawned assets purchased by SPE #2 from SPE #1. If cash is treated as being paid to the third party investor, there is a corresponding reduction in the balance on SPE #2's secured note, which is owned by the third party investor; if it is treated as reinvested, there may be no effect on SPE #2's secured note, but the pool of collateral supporting it will reflect the sale of the redeemed or purchased pawned assets and the acquisition of the new pawned items. Alternatively, depending on the particular system and method being implemented within the scope of this invention, the cash for redeemed assets received by the third party investor may be used by the third party investor to reinvest in additional balances on SPE #2's secured note.

During the revolving period, customers are also pawning new assets and cash is being loaned to those customers by the pawnshop. In order to enable the pawnshop to continue the securitization process for the newly pawned assets, these newly pawned assets are sold in a true sale by the pawnshop to SPE #1, which pays a purchase price to the pawnshop, the price comprising cash and, if necessary, a new note or, more conveniently, an increase in the amount of the existing note (the SPE #1 note). Those newly pawned assets are then sold in a true sale by SPE #1 to SPE #2, the purchase price usually being paid either by an increase in the amount due under SPE #2's secured note or in cash received by SPE #2 in payment for the redeemed pawned items. If the note increases, SPE #1 then sells the increased amount due under the SPE #2 secured note to the third party investor for cash and an additional deferred payment obligation.

All parties benefit: the pawnshop can continue to purchase pawned assets using the cash provided by the third party investor; the third party investor continues to obtain a return on its investment without the need to enter into a new securitization; and the owners of SPE #2 usually obtain additional compensation for purchasing the additional pawned items.

On any given day (or other time period), the net flows of cash between the parties in each pair of parties (e.g., the third party investor and SPE #1, the pawnshop and SPE #1, the pawnshop and SPE #2, the third party investor and SPE #2) may be from either party to the other, depending on the total value of the particular assets redeemed or sold and the total value of the newly pawned assets purchased that day (or other time period).

Desirably, the notes and other documents creating the structure are written so that changes resulting from day-to-day pawnshop operations, e.g., increases or reductions in the amount of the secured note and changes in the security for it (resulting from redemption or sale of pawned assets and acquisition of new pawned assets), do not result in the physical transfer of pawned assets, the daily movement of funds, or the revision or redraft of the notes and other documents.

One or more bank accounts desirably are used to hold and net out the daily cash flows, with one of them (e.g., a lockbox account) established to receive the pawnshop's redemption and sale receipts in the name of SPE #2 (which owns the pawned assets), which are then paid by SPE #2 to the third party investor (which owns SPE #2's secured note) in order to pay down the secured note or, depending on the structure of the particular system and method, the cash may be paid by SPE #2 to SPE #1 as the purchase price for the newly pawned assets and SPE #1 can use the cash to purchase newly pawned assets from the pawnshop.

Still with respect to FIG. 14, as various flows between the parties occur (of assets, cash, rights, and obligations), the agreements between the third party investor and the investors may specify the date on or conditions upon which investors' certificates (e.g., securities) must be partially or totally paid or redeemed (e.g., the date the revolving period ends). In the interim (i.e., after issuance of the certificates and prior to any redemption of such certificates and absent any significant non-performance issues), the security for the certificates, which is based on the value of the pawned assets securing SPE #2's secured note plus any cash received by the third party investor in repayment of the secured note, should remain approximately constant since the value of pawned assets sold or redeemed in a given time period should be approximately the same as the value of newly pawned assets acquired by the pawnshop and transferred to SPE #1 and then to SPE #2 in that time period.

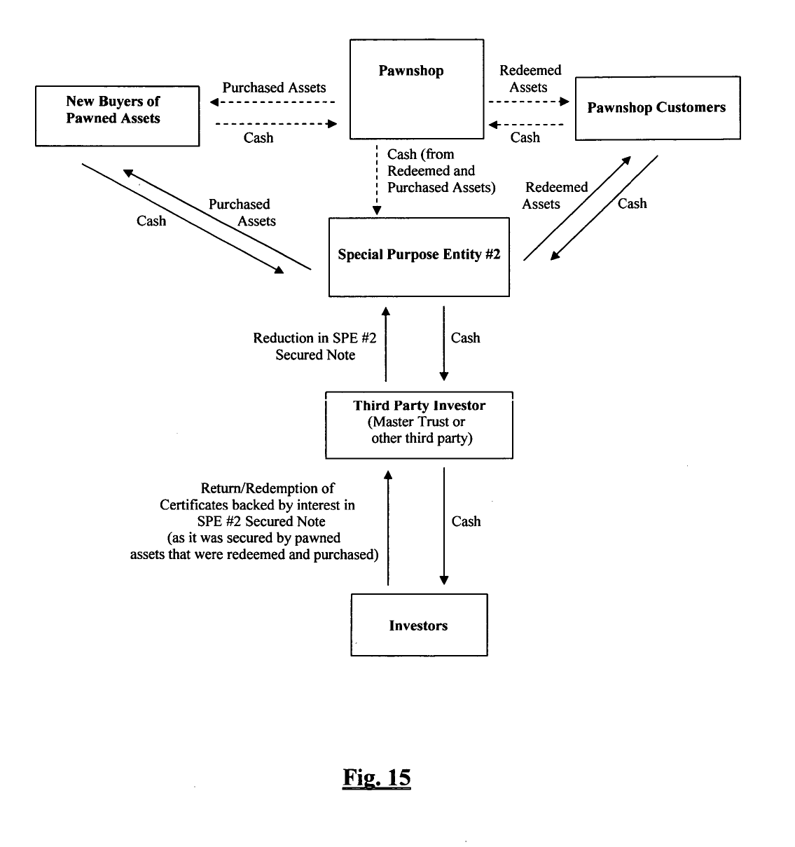

FIG. 15 shows for the amortization (paydown) period the cash and other flows before the SPE #2 Secured Note has been fully paid off by SPE #2, before the third party investor pays all of the deferred purchase price to SPE #1, and before SPE #1 pays off its note held by the pawnshop. During the amortization period, no new assets are being transferred to SPE #1 and through SPE #1 to SPE #2. More specifically, although the pawnshop may be operating, it either is not accepting nay new pawned assets (and therefore is not making payments based on them) or it is accepting pawns and making payments, but those pawns and payments are not part of the current set of transactions being implemented using the method of this invention (in other words, the same pawnshop may be in business, but the agreements covering the current set of transactions do not cover the new pawned assets and SPE #1 and SPE #2 do not buy any of these new pawned assets).

During this period, cash is received by the pawnshop for redemptions by the customers of pawned assets and for sales to buyers of unredeemed pawned assets. Conceptually, cash received by the pawnshop from the redemption and sale to new buyers of pawned assets flows to SPE #2, which is the owner of the pawned assets, and then is paid by SPE #2 to the third party investor to reduce the unpaid balance on the SPE #2 Secured Note, which the third party investor owns. At the same time, title to the assets owned by SPE #2 flows to the pawnshop customers and to the new buyers in exchange for the cash payments, and the security backing the SPE #1 Note is reduced to the extent that collateral was provided by the pawned assets that have been redeemed and sold. Depending on the provisions of the agreements implementing this system and method of the invention, the third party investor will likely be required to start redeeming or making principal payments on some or all of the certificates held by the individual investors before paying any part of the deferred purchase price. For example, the agreements may require the third party investor to redeem the investors' certificates to the extent the value of the SPE #2 Secured Note held by the third party investor is reduced by the outflow of pawned assets from SPE #2 that are being redeemed and purchased.

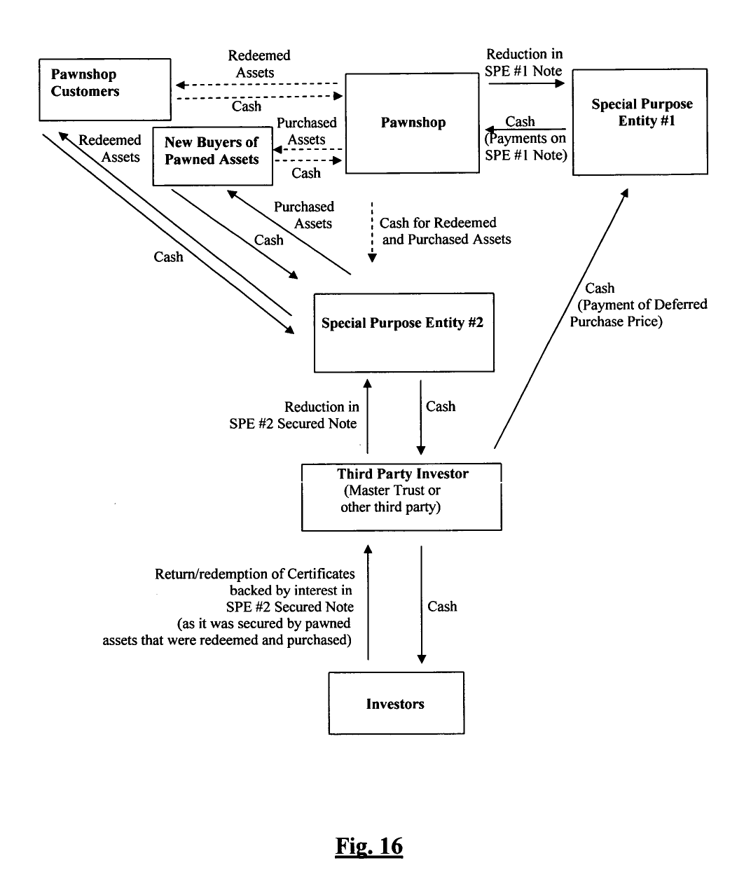

FIG. 16 shows for the amortization period the cash and other flows when the cash flow is sufficient for the third party investor to pay the deferred purchase price owed to SPE #1. During this period, cash continues to be received by the pawnshop (as agent for SPE #2) from redemptions by the customers of pawned assets and for sales to buyers of unredeemed pawned assets. The cash received flows to SPE #2, which is the owner of the pawned assets, and then is paid by SPE #2 to the third party investor to reduce the unpaid balance on the SPE #2 Secured Note (which the third party investor owns). At the same time, title to the pawned assets owned by SPE #2 flows to the pawnshop customers and to the new buyers, and the security backing the SPE #2 Secured Note is reduced to the extent that collateral was provided by the pawned assets that have been redeemed and sold. Once the net cash received by the third party investor exceeds the cash portion of the purchase price paid by the third party investor to SPE #1 for the SPE #2 Secured Note plus accrued and unpaid interest thereon and other required expenses of the securitization, the third party investor can use the cash it receives to pay the deferred purchase price to SPE #1. SPE #1, in turn, uses this cash to make payments on its note to the pawnshop. If the assets perform as expected, eventually enough cash flows from the pawnshop to SPE #2, to the third party investor, to SPE #1, and then back to the pawnshop to pay off the SPE #2 Secured Note, the third party investor's deferred payment obligations to SPE #1, and SPE #1's note to the pawnshop.

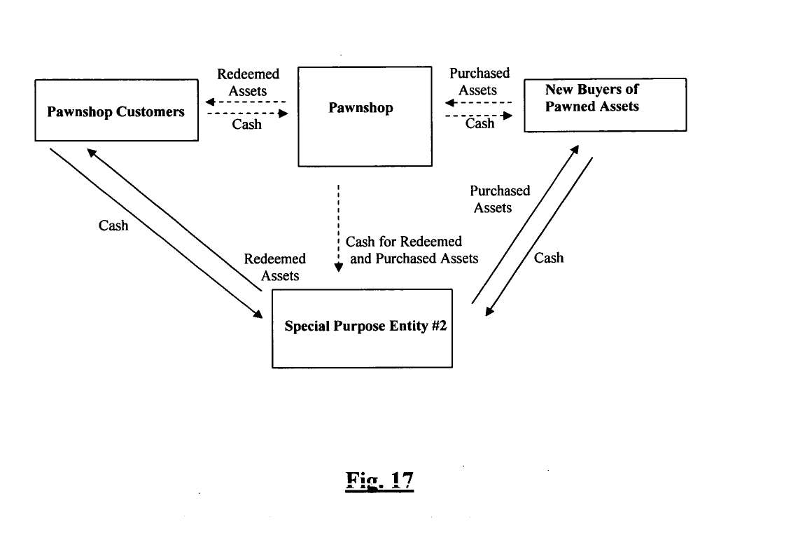

FIG. 17 shows for the amortization period the cash and other flows after the SPE #2 Secured Note, the SPE #1 note, and the deferred purchase price for the SPE #2 Secured Note have been repaid. Any cash received by the pawnshop (as agent for SPE #2) from redemptions by the customers of pawned assets and for sales to new buyers of unredeemed pawned assets flows to SPE #2, which is still the owner of the pawned assets, and title to the assets owned by SPE #2 flows to the pawnshop customers and the new buyers. Because the SPE #2 Secured Note and all related expenses have been paid in full, additional cash received by the pawnshop from the redemption and sale of the pawned assets flows to SPE #2 for its own account, which is one way that SPE #2 makes a profit for its owner.

As a hypothetical example to illustrate the advantages of this embodiment of the invention, assume that in return for $1.9 million, the pawnshop sells to and contributes to the capital of SPE #1 pawned assets having a total estimated disposition value of $2 million, which the pawnshop purchased for $1 million. Assume the capital contribution consists of pawned assets with a total disposition value of $0.7 million and the remaining consideration is comprised of $1 million in cash plus $0.2 million in a subordinated note. SPE #1, in turn, sells the pawned assets to SPE #2 for a $1.9 million note created or issued (e.g., made) by SPE #2 and secured by the pawned assets being purchased (having an estimated disposition value of $2 million). A third party investor buys the $1.9 million SPE #2 Note from SPE #1 for $1.9 million, consisting of $1 million in cash and $0.9 million in the form of a deferred payment obligation or note.

From the pawnshop's perspective, it has sold and/or contributed pawned assets that cost it $1 million (and with an expected disposition value of $2 million) and it received three assets in return $1 million in cash, all of the equity of SPE #1 ($0.7 million), and SPE #1's $0.2 million subordinated note. SPE #1 has, in turn, received $1 million in cash and $0.9 million in the form of a deferred payment obligation from the third party investor. The pawnshop expects the $0.9 million in deferred payment obligations to be paid to SPE #1 (since such payments are a function solely of the redemption and sale of the pawned assets in amounts consistent with the pawnshop's historical practice) and, as a result, the pawnshop expects to and should receive payment in full of the $0.2 million note and $0.7 million for its equity interest in SPE #1.

As a result of invention, the pawnshop would likely obtain more favorable rates than if it used traditional financing methods. In addition, a traditional lending source would probably loan funds to the pawnshop, secured by the pawned assets, based on a percentage, often substantially less than 100% of the actual cost to the pawnshop of the pawned assets, i.e., less than the $1 million in the example. Thus, the inventors believe that in most cases, the pawnshop's cost of obtaining funding through securitizations according to this invention will be less than the cost from traditional lending sources and/or that the pawnshop will be able to borrow greater amounts. Furthermore, in the example, the consolidated financial statement of the pawnshop enterprise, for financial reporting purposes, may or may not include the SPE #2 Secured Note as a liability, may or may not include the pawned assets sold to SPE #1 and then to SPE #2 as an asset, but should include as assets the cash the pawnshop enterprise received, the SPE #1 note it received, and its equity interest in SPE #1. SPE #1 is entitled to the deferred purchase price, which should, in turn, be reflected on SPE #1's balance sheet. The net result should be a stronger financial statement for the pawnshop enterprise, which, in turn, may help lower the pawnshop enterprise's borrowing costs from traditional lenders and/or allow it to obtain more funding than it would otherwise be able to obtain, which can then be used by it to purchase more pawned assets and/or for any other company purposes.

From the third party investor's perspective, it made a safe investment and received a reasonable return (the interest on the secured note). It bought a $1.9 million note secured by assets with an estimated disposition value of $2 million for $1 million in cash with the other $0.9 million being deferred and not owing and payable until, and only to the extent that, sufficient proceeds from the sale or redemption of the pawned assets securing the note were obtained. It was not obligated to pay any portion of the deferred payment until it received back $1 million plus interest on the SPE #2 Secured Note, thus compensating it for the $1 million of cash paid to SPE #1.

From SPE #2's perspective, it used a $1.9 million promissory note to purchase pawned assets with a disposition value of $2 million, $0.1 million more than the face amount of the note, which gave it the reasonable expectation that it would likely not lose money and should compensate it for making the investment (ignoring the time value of money, i.e., the obligation to make interest payments on the face amount of the secured note, which the parties will take into account through a further decrease in the purchase price paid by SPE #1 to the pawnshop, and by SPE #2 to SPE #1, for the pawned assets). Furthermore, SPE #2 became the owner of the pawned assets so that after it paid off the secured note, the income from any further redemption and sale of the pawned assets was solely for its own account.

As noted above, combining other financial assets (e.g., financial assets comprising or involving instruments based on check cashing, payday loans, rent-to-own agreements, rental agreements, sub-prime loans, refund anticipation loans, and/or title pawn loans) with the pawned assets (or equivalently, with a secured financial instrument based on the pawned assets) allows a pawnshop enterprise to securitize its physical assets (i.e., the pawned assets) and intangible assets (financial assets) together and thereby obtain one or more of the benefits of this invention. The drawings do not show the flow of the other financial assets, but it should be understood that they can flow from the pawnshop along with the pawned assets to the first entity and then to any subsequent entities and/or with the secured financial instrument that is created based on the pawned assets, or the other financial assets can flow in any acceptable way that is not identical to the flow of pawned assets and/or secured financial instrument. One or more of the other financial assets may be combined with the pawned assets so that consideration (e.g., the first consideration) is given for the combination and not for just the pawned assets. One or more of the other financial assets may be combined with the secured financial instrument so that consideration (e.g., the second consideration) is given for the combination and not just for the secured financial instrument. Regardless of the flow of the other financial assets (as such or as their equivalent), the one or more other financial assets in question (as such or as their equivalent) desirably are eventually in the hands of the second entity so that the certificates can be based at least in part on them as well as on the secured financial instrument. Preferably, but not necessarily, the second consideration is given by the second entity (to whoever the transferor(s) is/are) in return for the one or more other financial assets and secured financial instrument. Preferably, but not necessarily, at least one of the other financial assets in question is transferred to the first entity by the pawnshop enterprise, some or all of which other financial assets may or may not flow along the same path as the pawned assets and/or secured financial instrument.

As illustrated by the foregoing, the present invention has many advantages, including enabling a pawnshop enterprise to create a financial asset from its physical assets, which financial asset can be used to support a securitization. Furthermore, the securitization can be utilized in either an on-balance sheet or off-balance sheet manner. Moreover, as described above, an entity or group of entities having both physical assets and financial assets can combine or facilitate combining the different types of assets in one securitization vehicle and, therefore, that entity or group of entities can facilitate a securitization using all or almost all of its or their combined assets. Other features and advantages of the various aspects of the invention will be apparent to those skilled in the art from this disclosure.

As previously noted, FIGS. 2 to 5 illustrate one system and method for implementing the general system and method of FIG. 1, FIGS. 7 to 11 illustrate one system and method for implementing the general system and method of FIG. 6, and FIGS. 13 to 17 illustrate a system and method for implementing the general system and method of FIG. 12. Other schemes within the scope of those generalized systems and methods besides those shown in FIGS. 2 to 5, 7 to 11, and 13 to 17 are possible and are within the scope of the invention and claims.

For the sake of simplicity, the drawings illustrate direct relations between various entities (e.g., SPE #1 being a wholly owned subsidiary of the pawnshop) and direct flows between entities of obligations, rights, consideration, assets, notes, etc. (e.g., the sale of pawned assets by SPE #1 to SPE #2). It should be apparent to those skilled in the art that indirect (in addition to direct) relations and flows between the various entities are possible (the written description in some cases does refer to indirect relations and flows). For example, there may be an intermediate entity between the pawnshop and SPE #1 (e.g., wholly owned by the pawnshop and wholly owning SPE #1) through which pass the pawned assets being transferred from the pawnshop to SPE #1. As another example, SPE #1 may sell the pawned assets to an intermediate entity, which then sells them to SPE #2. (Furthermore, certain SPEs could also be orphan entities (i.e., specially formed SPEs that are not subsidiaries of any of the parties to the transaction.)

The claims are intended to cover all direct and indirect relations and direct and indirect flows, and the claims should be understood to do so. Thus, e.g., the phrase “causing, participating in, structuring, financing, negotiating, or otherwise facilitating the transfer of a secured financial instrument to a second entity for a second consideration” should be understood to cover both direct transfer (e.g., assignment or issuance) of the secured financial instrument to the second entity as well as indirect transfer (e.g., assignment or issuance) of the secured financial instrument to the second entity (e.g., through one or more intermediate entities). As another example, the phrase “at least some of the pawnshop enterprise's pawned assets are transferred by the first entity to a third entity for a third consideration” should be understood to cover both direct and indirect transfer by the first entity to the third entity.

Also for the sake of simplicity, the drawings usually illustrate and the description usually refers to single entities (e.g., each pawnshop box in the drawings is labeled with the singular “Pawnshop”); however, it should be apparent that two or more pawnshops could take the place of a single pawnshop, two or more SPE #1s could take the place of a single SPE #1, etc. The claims are also intended to cover all such multiplication or split of entities.

As will be understood by one skilled in the art, there are a number of financial and legal issues (involving tax, bankruptcy, corporate, secured transactions, and other areas of the law) that will affect how any particular set of transactions utilizing the present invention is structured. Accordingly, legal advice should be obtained before putting in place any system and method according to the invention. Examining the facts and circumstances underlying a proposed set of transactions, taking the financial and legal factors into consideration, and drafting the appropriate documents (e.g., secured notes, subordinated notes, certificate holder agreements, trust agreements, and asset sale agreements) are well within the skill of one of ordinary skill in the art.

The invention has been described in an illustrative manner and, except as otherwise noted, the terminology that has been used is intended to be in the nature of description rather than of limitation. Modifications and variations that can be made should be apparent in light of the teachings herein. It is, therefore, to be understood that within the scope of the claims, the invention can be practiced otherwise than as specifically described and that the claims are intended to cover all modifications and variations falling within the true spirit and scope of the invention.

We claim:

1. A method for facilitating the securitization of the pawned assets of a pawnshop enterprise, the method comprising the steps:
(a) causing, participating in, structuring, financing, negotiating, or otherwise facilitating the transfer of at least some of the pawnshop enterprise's pawned assets to a first entity for a first consideration; and
(b) causing, participating in, structuring, financing, negotiating, or otherwise facilitating the transfer of a secured financial instrument to a second entity for a second consideration, the secured financial instrument being secured at least in part by at least some of the pawned assets that were transferred by the pawnshop enterprise.

2. The method of claim 1 wherein the transfer of the pawnshop enterprise's pawned assets to the first entity comprises a true sale and/or a true contribution.

3. The method of claim 1 wherein the first consideration comprises cash and/or a note and/or equity in the first entity.

4. The method of claim 1 wherein the first consideration comprises a subordinated note.

5. The method of claim 1 wherein the first entity is bankruptcy-remote.

6. The method of claim 1 wherein the first entity is a wholly owned subsidiary of the pawnshop enterprise.

7. The method of claim 1 wherein the first entity is a special purpose entity.

8. The method of claim 1 wherein the second consideration comprises cash and/or a note and/or a deferred purchase price.

9. The method of claim 8 wherein payment of the deferred purchase price comprising the second consideration is contingent upon the performance of the pawnshop enterprise.

10. The method of claim 1 wherein the second consideration comprises a loan.

11. The method of claim 1 wherein the second entity is an entity that can transfer beneficial interests in the secured financial instrument to investors.

12. The method of claim 1 wherein the second entity is a trust.

13. The method of claim 1 wherein the transfer of the pawnshop enterprise's pawned assets to the first entity comprises a true sale and/or a true contribution, the first consideration comprises cash and/or a note and/or equity in the first entity, the first entity is bankruptcy-remote, the second consideration comprises cash and/or a note and/or a deferred purchase price, and the second entity is an entity that can transfer beneficial interests in the secured financial instrument to investors.

14. The method of claim 13 wherein the first entity is a wholly owned subsidiary of the pawnshop enterprise and the second entity is a trust.

15. The method of claim 13 wherein the first entity is a special purpose entity whose allowed activities comprise purchasing the pawned assets for the first consideration.

16. The method of claim 13 wherein the second consideration comprises a loan.

17. The method of claim 13 wherein the note of the first consideration is a subordinated note.

18. The method of claim 1 wherein the secured financial instrument is created or issued by the first entity.

19. The method of claim 18 wherein the transfer of the pawnshop enterprise's pawned assets to the first entity comprises a true sale and/or a true contribution, the first consideration comprises cash and/or a note and/or equity in the first entity, the first entity is bankruptcy-remote, the second consideration comprises cash and/or a note and/or a deferred purchase price, and the second entity is an entity that can transfer beneficial interests in the secured financial instrument to investors.

20. The method of claim 19 wherein the first entity is a wholly owned subsidiary of the pawnshop enterprise and the second entity is a trust.

21. The method of claim 19 wherein the first entity is a special purpose entity whose allowed activities comprise purchasing the pawned assets for the first consideration.

22. The method of claim 19 wherein the second consideration comprises a loan.

23. The method of claim 19 wherein the note of the first consideration is a subordinated note.

24. The method of claim 19 wherein the first entity is a wholly owned subsidiary of the pawnshop enterprise, the second entity is a trust, the second consideration comprises a loan, and the note of the first consideration is a subordinated note.

25. The method of claim 24 wherein the first entity is a special purpose entity whose allowed activities comprise purchasing the pawned assets for the first consideration.

26. The method of claim 1 wherein at least some of the pawnshop enterprise's pawned assets are transferred by the first entity to a third entity for a third consideration.

27. The method of claim 26 wherein the transfer of the pawnshop enterprise's pawned assets to the first entity comprises a true sale and/or a true contribution and the transfer of at least some of the pawnshop enterprise's pawned assets by the first entity to the third entity comprises a true sale.

28. The method of claim 26 wherein the secured financial instrument is created or issued by the third entity.

29. The method of claim 28 wherein the third consideration comprises the secured financial instrument.

30. The method of claim 28 wherein the third consideration comprises cash and/or a subordinated note and/or a deferred purchase price.

31. The method of claim 26 wherein the first consideration comprises cash and/or a note and/or equity in the first entity.

32. The method of claim 26 wherein the first entity is bankruptcy-remote.

33. The method of claim 26 wherein the first entity is a wholly owned subsidiary of the pawnshop enterprise.

34. The method of claim 26 wherein the first entity is a special purpose entity.

35. The method of claim 26 wherein the second consideration comprises cash and/or a note and/or a deferred purchase price.

36. The method of claim 26 wherein the second consideration comprises a loan.

37. The method of claim 26 wherein the second entity is an entity that can transfer beneficial interests in the secured financial instrument to investors.

38. The method of claim 26 wherein the second entity is a trust.

39. The method of claim 26 wherein the third entity is bankruptcy-remote.

40. The method of claim 26 wherein the third entity is a special purpose entity.

41. The method of claim 26 wherein the transfer of the pawnshop enterprise's pawned assets to the first entity comprises a true sale and/or a true contribution, the transfer of at least some of the pawnshop enterprise's pawned assets by the first entity to the third entity comprises a true sale, the secured financial instrument is created or issued by the third entity, the first consideration comprises cash and/or a note and/or equity in the first entity, the first entity is bankruptcy-remote, the second consideration comprises cash and/or a note and/or a deferred purchase price, the second entity is an entity that can transfer beneficial interests in the secured financial instrument to investors, the third entity is bankruptcy-remote, and/or the third consideration comprises the secured financial instrument and/or cash and/or a subordinated note and/or a deferred purchase price.

42. The method of claim 41 wherein the first entity is a wholly owned subsidiary of the pawnshop enterprise and the second entity is a trust.

43. The method of claim 41 wherein the first entity is a special purpose entity whose allowed activities comprise purchasing the pawned assets for the first consideration.

44. The method of claim 41 wherein the second consideration comprises a loan.

45. The method of claim 41 wherein the second consideration comprises cash and/or a deferred purchase price.

46. The method of claim 45 wherein payment of the deferred purchase price to the first entity is contingent upon the performance of the pawnshop enterprise in selling the pawned assets securing the secured financial instrument.

47. The method of claim 41 wherein the third entity is a special purpose entity whose allowed activities comprise purchasing the pawned assets for the third consideration.

48. The method of claim 1 further comprising causing, participating in, structuring, financing, negotiating, or otherwise facilitating the transfer to the second entity of one or more other financial assets in addition to the secured financial instrument.

49. The method of claim 48 wherein the second consideration is given in return for the one or more other financial assets and secured financial instrument.

50. The method of claim 48 wherein at least one of the other financial assets is transferred to the first entity by the pawnshop enterprise.

51. The method of claim 48 wherein the one or more other financial assets comprise or involve instruments based on check cashing, payday loans, rent-to-own agreements, rental agreements, sub-prime loans, refund anticipation loans, and/or title pawn loans.

52. A method for a pawnshop enterprise to facilitate securitization of its pawned assets, the method comprising the steps:
(a) causing, participating in, structuring, financing, negotiating, or otherwise facilitating the transfer of at least some of its pawned assets to a first entity for a first consideration; and
(b) causing, participating in, structuring, financing, negotiating, or otherwise facilitating the transfer of a secured financial instrument to a second entity for a second consideration, the secured financial instrument being secured at least in part by at least some of the pawned assets that were transferred by the pawnshop enterprise.

53. The method of claim 52 wherein the transfer of the pawnshop enterprise's pawned assets to the first entity comprises a true sale and/or a true contribution, the first consideration comprises cash and/or a note and/or equity in the first entity, the first entity is bankruptcy-remote, the second consideration comprises cash and/or a note and/or a deferred purchase price, and the second entity is an entity that can transfer beneficial interests in the secured financial instrument to investors.

54. The method of claim 53 wherein the first entity is a wholly owned subsidiary of the pawnshop enterprise and the second entity is a trust.

55. The method of claim 53 wherein the first entity is a special purpose entity whose allowed activities comprise purchasing the pawned assets for the first consideration.

56. The method of claim 53 wherein the second consideration comprises a loan.

57. The method of claim 53 wherein the note of the first consideration is a subordinated note.

58. The method of claim 52 wherein the secured financial instrument is created or issued by the first entity.

59. The method of claim 58 wherein the transfer of the pawnshop enterprise's pawned assets to the first entity comprises a true sale and/or a true contribution, the first consideration comprises cash and/or a note and/or equity in the first entity, the first entity is bankruptcy-remote, the second consideration comprises cash and/or a note and/or a deferred purchase price, and the second entity is an entity that can transfer beneficial interests in the secured financial instrument to investors.

60. The method of claim 59 wherein the first entity is a wholly owned subsidiary of the pawnshop enterprise, the second entity is a trust, the second consideration comprises a loan, and the note of the first consideration is a subordinated note.

61. The method of claim 59 wherein the first entity is a special purpose entity whose allowed activities comprise purchasing the pawned assets for the first consideration.

62. The method of claim 52 wherein at least some of the pawnshop enterprise's pawned assets are transferred by the first entity to a third entity for a third consideration.

63. The method of claim 62 wherein the transfer of the pawnshop enterprise's pawned assets to the first entity comprises a true sale and/or a true contribution and the transfer of at least some of the pawnshop enterprise's pawned assets by the first entity to the third entity comprises a true sale.

64. The method of claim 62 wherein the secured financial instrument is created or issued by the third entity.

65. The method of claim 64 wherein the third consideration comprises the secured financial instrument and/or cash and/or a subordinated note and/or a deferred purchase price.

66. The method of claim 62 wherein the first entity is bankruptcy-remote.

67. The method of claim 62 wherein the second consideration comprises a loan.

68. The method of claim 62 wherein the second consideration comprises a deferred purchase price.

69. The method of claim 62 wherein the second entity is an entity that can transfer beneficial interests in the secured financial instrument to investors.

70. The method of claim 62 wherein the transfer of the pawnshop enterprise's pawned assets to the first entity comprises a true sale and/or a true contribution, the transfer of at least some of the pawnshop enterprise's pawned assets by the first entity to the third entity comprises a true sale, the secured financial instrument is created or issued by the third entity, the first consideration comprises cash and/or a note and/or equity in the first entity, the first entity is bankruptcy-remote, the second consideration comprises cash and/or a note and/or a deferred purchase price, the second entity is an entity that can transfer beneficial interests in the secured financial instrument to investors, the third entity is bankruptcy-remote, and/or the third consideration comprises the secured financial instrument and/or cash and/or a subordinated note and/or a deferred purchase price.

71. The method of claim 70 wherein the first entity is a wholly owned subsidiary of the pawnshop enterprise and the second entity is a trust.

72. The method of claim 70 wherein the second consideration comprises a loan.

73. The method of claim 70 wherein the second consideration comprises cash and/or a deferred purchase price.

74. The method of claim 73 wherein payment of the deferred purchase price to the first entity is contingent upon the performance of the pawnshop enterprise in selling the pawned assets securing the secured financial instrument.

75. The method of claim 52 further comprising causing, participating in, structuring, financing, negotiating, or otherwise facilitating the transfer to the second entity of one or more other financial assets in addition to the secured financial instrument.

76. The method of claim 75 wherein the second consideration is given in return for the one or more other financial assets and secured financial instrument.

77. The method of claim 75 wherein at least one of the other financial assets is transferred to the first entity by the pawnshop enterprise.

78. The method of claim 75 wherein the one or more other financial assets comprise or involve instruments based on check cashing, payday loans, rent-to-own agreements, rental agreements, sub-prime loans, refund anticipation loans, and/or title pawn loans.

79. A method for securitizing at least some of the pawned assets of a pawnshop enterprise, the method comprising creating, issuing, underwriting, or offering securities backed by the secured financial instrument of claim 1.

80. A method for securitizing at least some of the pawned assets of a pawnshop enterprise, the method comprising creating, issuing, underwriting, or offering securities backed by the secured financial instrument of claim 13.

81. A method for securitizing at least some of the pawned assets of a pawnshop enterprise, the method comprising creating, issuing, underwriting, or offering securities backed by the secured financial instrument of claim 18.

82. A method for securitizing at least some of the pawned assets of a pawnshop enterprise, the method comprising creating, issuing, underwriting, or offering securities backed by the secured financial instrument of claim 19.

83. A method for securitizing at least some of the pawned assets of a pawnshop enterprise, the method comprising creating, issuing, underwriting, or offering securities backed by the secured financial instrument of claim 26.

84. A method for securitizing at least some of the pawned assets of a pawnshop enterprise, the method comprising creating, issuing, underwriting, or offering securities backed by the secured financial instrument of claim 41.

85. A method for securitizing at least some of the pawned assets of a pawnshop enterprise, the method comprising creating, issuing, underwriting, or offering securities backed by the secured financial instrument of claim 52

86. A method for securitizing at least some of the pawned assets of a pawnshop enterprise, the method comprising creating, issuing, underwriting, or offering securities backed by the secured financial instrument of claim 53.

87. A method for securitizing at least some of the pawned assets of a pawnshop enterprise, the method comprising creating, issuing, underwriting, or offering securities backed by the secured financial instrument of claim 58.

88. A method for securitizing at least some of the pawned assets of a pawnshop enterprise, the method comprising creating, issuing, or underwriting, offering securities backed by the secured financial instrument of claim 59.

89. A method for securitizing at least some of the pawned assets of a pawnshop enterprise, the method comprising creating, issuing, underwriting, or offering securities backed by the secured financial instrument of claim 62.

90. A method for securitizing at least some of the pawned assets of a pawnshop enterprise, the method comprising creating, issuing, underwriting, or offering securities backed by the secured financial instrument of claim 70.

91. A method for securitizing at least some of the pawned assets of a pawnshop enterprise, the method comprising creating, issuing, underwriting, or offering securities backed by the secured financial instrument of claim 75.
